(19) United States
(12) Patent Application Publication
(10) Pub. No.: US 2026/0244464 A1
(43) Pub. Date: Aug. 20, 2026

(54) INSTALLATION GUIDANCE FOR INSTALLING DEVICES IN A LOAD CONTROL SYSTEM

(71) Applicant: Lutron Technology Company LLC, Coopersburg, PA (US)

(72) Inventors: Joseph C. Guellnitz, Albrightsville, PA (US); Somesh Rahul, Breinigsville, PA (US); Stephen Santoro, Northampton, PA (US); Ekta Verma, Sunnyvale, CA (US)

(73) Assignee: Lutron Technology Company LLC, Coopersburg, PA (US)

(21) Appl. No.: 18/871,127

(22) PCT Filed: Jun. 2, 2023
(86) PCT No.: PCT/US2023/024354

§ 371 Date: Dec. 2, 2024

Related U.S. Application Data
(60) Provisional application No. 63/348,390, filed on Jun. 2, 2022.

(51) Int. Cl. G06F 9/451

(52) U.S. Cl. CPC G06F 9/453

(57) ABSTRACT

An installation guidance procedure may be provided for installing a device in a load control system. The installation guidance procedure may be provided via installation guidance software executed on one or more devices. A device may be identified by the installation guidance software for being installed in the load control system. Images may be generated and received from a camera of a user device for identifying wires in a wiring installation in the load control system. The installation guidance software may identify, from the at least one image, wiring characteristics of the different wires. The installation guidance software may display, via a display of the user device, installation guidance for wiring the wires to the device based on the wiring characteristics of each of the wires.

### CROSS-REFERENCE TO RELATED APPLICATIONS

This application claims the benefit of U.S. Provisional Patent application No. 63/348,390, filed Jun. 2, 2022, the entire disclosure of which is hereby incorporated by reference herein.

### BACKGROUND

A user environment, such as a residence, an office building, or a hotel for example, may be configured to include various types of load control systems. For example, a lighting control system may be used to control the lighting loads in the user environment. A motorized window treatment control system may be used to control the natural light provided to the user environment. A heating, ventilating, and air conditioning (HVAC) system may be used to control the temperature in the user environment.

### SUMMARY

Systems, methods, and apparatus are described for providing an installation guidance procedure for installing a device in a load control system. For example, the installation guidance procedure may be provided via installation guidance software executed on one or more devices. A device may be identified by the installation guidance software for being installed in the load control system. Images may be generated and received from a camera of a user device for identifying wires in a wiring installation in the load control system. The installation guidance software may identify, from an at least one image, wiring characteristics of the different wires. The wiring characteristics may be identified from the at least one image using an artificial intelligence (AI) and/or machine learning (ML) algorithm, such as a neural network (NN) or a linear regression algorithm that has been trained on training data to identify the wiring characteristics. The installation guidance software may display, via a display of the user device, installation guidance for wiring the wires to the device based on the wiring characteristics of each of the wires. In one example, the installation guidance procedure may provide step-by-step guidance for replacing a first lighting switch with a second lighting switch or dimmer switch.

Each wire may be tagged in memory with a descriptor indicating a type of wire that has been identified from the at least one image. Tags may be removed for wires that may be mistakenly tagged or that may not be used in the installation. The descriptor may be displayed on the user device with a tag removal actuator for each wire that has been identified from the at least one image. An actuation of the tag removal actuator may be received for a wire identified from the at least one image. The tagging of the wire may be removed from memory and the wire may fail to be included in the installation guidance procedure that is provided on the user device.

Tags may be added for wires that fail to be automatically tagged. An add tag actuator may be displayed on the user device that is configured to add a tagging of a wire in the at least one image. The user device may receive an actuation of the add tag actuator and subsequently receive an indication of a location of the wire in the at least one image. The user device may receive a descriptor of the tagged wire and tag the location of the wire with the descriptor in memory. The tagged wire may be displayed on the display of the user device with the descriptor. The tagged wire may be used in the installation guidance procedure that is provided on the user device.

The device that is being installed may be a replacement device for a currently installed device in the load control system. Device characteristics of the currently installed device may also be identified from the at least one image. The installation guidance procedure may also be based on the device characteristics of the currently installed device.

The installation guidance procedure may include step-by-step instructions for disconnecting each wire from the currently installed device and connecting the wires to a location on the replacement device. Indicators may be displayed on the user device for each wire that has been identified in the at least one image from the wiring installation. Indicators may also be displayed at a location on the replacement device for connecting a corresponding wire of the at least one wire. The indicators on the wires may be a color of the wire for which the indicator is displayed. The indicators on the locations of the replacement device may be a color of the location on the replacement device to which the wires are to be connected to the replacement device. An image of the replacement device on may be displayed on the display of the user device and the indicators of the locations of the replacement device may be displayed on the image of the replacement device to indicate the location on the replacement device for connecting the corresponding wires.

The installation guidance software may display a customer support icon on the display of the user device for contacting a customer support representative. In response to receiving an actuation of the customer support icon, a customer support representative may be called at a remote computing system from the user device. In response to receiving the actuation of the customer support icon, the user device may also provide a video feed of one or more images captured by the camera of the user device to the remote computing system for access by the customer support representative.

### BRIEF DESCRIPTION OF THE DRAWINGS

FIG. 1A is a diagram of an example load control system.

FIG. 1B is a schematic illustration of an example system environment for training and/or implementing an artificial intelligence and/or machine learning (AI/ML) model for detecting device characteristics for identifying devices in an image and/or wiring characteristics for identifying wires in an image.

FIGS. 2A-2K show screen shots illustrating features of an example user interface that may be displayed by installation guidance software executed on a computing device for providing guidance to a user installing a device in a load control system.

FIGS. 3A-3E show additional screen shots illustrating features of an example user interface that may be displayed by installation guidance software executed on a computing device for providing guidance to a user installing a device in a load control system.

FIGS. 4A-4B show further screen shots illustrating features of an example user interface that may be displayed by installation guidance software executed on a computing device for providing guidance to a user installing a device in a load control system.

FIG. 5 is an example flowchart of a procedure for providing guidance to a user installing a device in a load control system.

FIG. 6 is an example flowchart of a procedure for updating an installation guidance procedure based on an indications to update.

FIG. 7 is an example flowchart of a procedure for replacing a currently installed device with a replacement device.

FIG. 8 is a block diagram depicting an example computing device.

FIG. 9 is a block diagram depicting an example load control device.

### DETAILED DESCRIPTION

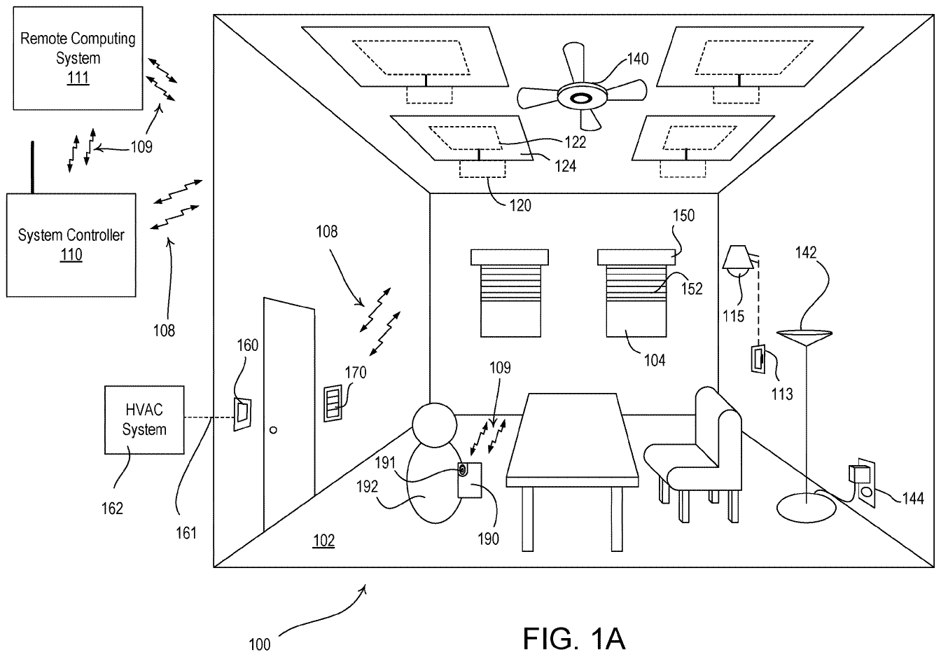

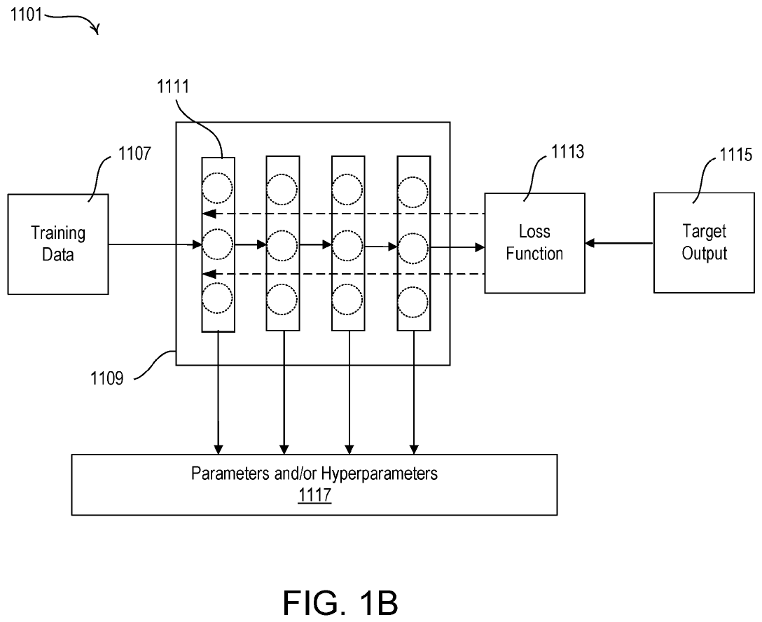

FIG. 1A is a diagram of an example load control system 100 for controlling the amount of power delivered from a power source, such as an alternating-current (AC) power source (not shown), to one or more electrical loads. The load control system 100 may be installed in a user environment 102. The user environment 102 may include a space in a residential or commercial building. For example, the load control system 100 may be installed in one or more rooms on one or more floors in the building.

The load control system 100 may comprise a plurality of load control devices installed throughout the user environment 102. The load control devices may be configured to control one or more electrical loads in the user environment 102 (also referred to as a load control environment). For example, the load control devices may control the one or more electrical loads in response to input from a user 192, input from one or more input devices or other devices in the load control system 100, and/or preprogrammed settings on the load control devices.

The load control devices in the load control system 100 may include lighting control devices, such as a lighting control device 113. The lighting control device 113 may be a wall-mounted dimmer switch, a wall-mounted on/off switch, a wall-mounted keypad device, or other wall-mounted lighting control device for controlling a lighting load(s), such as a lighting load 115, or combination thereof. The lighting control device 113 may be adapted to be mounted in a standard electrical wall box. The lighting control device 113 may include one or more buttons for controlling the lighting load 115. The lighting control device 113 may include a toggle actuator. Actuations (e.g., successive actuations) of the toggle actuator may toggle (e.g., turn off and on) the lighting load 115. The lighting control device 113 may include an intensity adjustment actuator (e.g., a slider control, a rocker switch, and/or other intensity adjustment buttons). Actuations of a portion of the intensity adjustment actuator may respectively increase or decrease the amount of power delivered to the lighting load 115 and thus increase or decrease the intensity of the receptive lighting load from a minimum intensity (e.g., approximately 1%) to a maximum intensity (e.g., approximately 100%). The lighting control device 113 may include a plurality (one or more) of visual indicators, e.g., light-emitting diodes (LEDs), which may be arranged in a linear array and that may illuminate to provide feedback of the intensity of the lighting load 115.

The lighting control device 113 may be replaced by or a replacement for another lighting control device in the wall box. The replaced lighting control device may be a single-pole switch, a double-pole switch, a three-way switch, a four-way switch, and/or another type of switch having a configuration for being connected to a wiring installation in the wall box. Some switches may also be configured with a neutral connection for connecting a neutral wire in the wiring installation. Though lighting switches (e.g., on/off and/or dimmer lighting switches) are provided as examples herein, it will be understood that other types of switches and other types of controls for controlling other electrical devices may similarly be connected as described herein (e.g., fan controls for controlling ceiling fans).

The load control devices in the load control system 100 may include lighting control devices, such as lighting control devices 120. The lighting control devices 120 may be controlled via wired or wireless control from a wall-mounted dimmer switch, a wall-mounted switch, a keypad device, and/or other lighting control device for controlling a lighting load(s). The lighting control devices 120 may be wired to the switches, dimmer switches, or other control devices in the load control system 100 via a wiring installation in the ceiling for receiving power and/or control signals. The lighting control devices 120 may be configured to control a respective lighting load 122 installed in a lighting fixture 124. For example, the lighting control devices 120 may comprise light-emitting diode (LED) drivers and the lighting loads 122 may comprise LED light sources. While each of the lighting fixtures 124 is shown having a single lighting load 122, each lighting fixture may comprise one or more individual light sources (e.g., lamps and/or LED emitters) that may be controlled individually and/or in unison by the respective lighting control device. Though described as an LED driver, the lighting control device 120 may be a dimmer switch, an electronic switch, a ballast, or another type of lighting control device configured to control one or more lighting loads 122. The lighting control device 120 may be configured to directly control an amount of power provided to the lighting load 122. The lighting control device 120 may be configured to receive (e.g., via wired or wireless communications) messages via signals 108,109, and to control the lighting load 122 in response to the received messages. One will recognize that the lighting control device 120 and the lighting load 122 may be integral and thus part of the same fixture or bulb, for example, or may be separate.

As described herein, a lighting control device, such as the lighting control device 113 and/or the lighting control device 120 may control a lighting load (e.g., or a plurality of lighting loads), such as the respective lighting loads 115 and 122, where the lighting load may include a plurality of multi-colored LEDs (light emitting diodes). In other words, the lighting loads 115, 122 may include within a single package, for example, a number of differently colored emission LEDs and may be configured such that the chromaticity output of the LEDs is mixed to produce light having varying chromaticity coordinates (e.g., color points) within a color gamut formed by the various LEDs that make up the lighting load. As one example, the lighting loads 115, 122 may include one or more red LEDs, one or more green LEDs, one or more blue LEDs, and one or more white LEDs (which may be collectively referred to herein as an RGBW lighting load). White LEDs may comprise substantially white LEDs (e.g., such as yellow and/or mint green LED(s)). Although the RGBW lighting load is described herein with a combination of four LEDs of certain colors, other combinations of LEDs (e.g., more or less LEDs and/or different color LEDs) may be used.

As described herein, a lighting control device, such as the lighting control device 113, may control a lighting load that is plugged into an electrical outlet. For example, the lighting control device 113 may be wired to control devices, such a floor lamp 142, that are plugged into electrical outlet 144. The electrical outlet 144 may be a standard electrical outlet 144 and thus may be coupled in series between the AC power source and the plug-in lighting load (e.g., floor lamp 142). The lighting load of the floor lamp 142 may be configured to receive messages via the one or more messages and to turn on and off or adjust the intensity, color, vibrancy, etc. of the lighting load in the floor lamp 142 in response to the received messages.

The load control devices in the load control system 100 may comprise a motor control unit for controlling a motor load, such as a ceiling fan 140. The ceiling fan 140 may be wired to fan speed controls or other control devices (e.g., similar to lighting control device 113) in the load control system 100 via a wiring installation in the ceiling for receiving power and/or control signals. The ceiling fan 140 may be controlled in response to signals received via wired and/or wireless signals. The ceiling fan 140 may be controlled to different speeds in response to the signals and/or other fan control etc.

The load control devices in the load control system 100 may comprise one or more temperature control devices, such as a thermostat 160, for controlling a temperature in the user environment 102. The thermostat 160 may be coupled to a heating, ventilation, and air conditioning (HVAC) system 162 via a control link 161. The thermostat 160 may be wired to the HVAC system via the wiring installation in the wall for controlling the HVAC system 162. The control link 161 may be an analog control link or a wired digital communication link. The thermostat 160 may be configured to wirelessly communicate messages with a controller of the HVAC system 162. The thermostat 160 may comprise a temperature sensor for measuring the room temperature of the user environment 102 and may control the HVAC system 162 to adjust the temperature in the user environment 102 to a setpoint temperature. The load control system 100 may comprise one or more wireless temperature sensors (not shown) located in the user environment 102 for measuring the room temperatures. The HVAC system 162 may be configured to turn a compressor on and off for cooling the user environment 102 and to turn a heating source on and off for heating the user environment 102 in response to the control signals received from the thermostat 160. The HVAC system 162 may be configured to turn a fan of the HVAC system on and off in response to the control signals received from the thermostat 160. The thermostat 160 and/or the HVAC system 162 may be configured to control one or more controllable dampers to control the air flow in the user environment 102. The thermostat 160 may be configured to receive messages via the RF signals 108, 109 and adjust heating, ventilation, and cooling in response to the received messages.

The load control system 100 may comprise one or more other types of load control devices, such as, for example, a screw-in luminaire including a dimmer circuit and an incandescent or halogen lamp; a screw-in luminaire including a ballast and a compact fluorescent lamp; a screw-in luminaire including an LED driver and an LED light source; an electronic switch, controllable circuit breaker, or other switching device for turning an appliance on and off; a motor control unit for controlling a motor load, such as an exhaust fan; a drive unit for controlling a motorized window treatment or a projection screen; motorized interior or exterior shutters; an air conditioner; a compressor; an electric baseboard heater controller; a controllable damper; a variable air volume controller; a fresh air intake controller; a ventilation controller; hydraulic valves for use radiators and radiant heating system; a humidity control unit; a humidifier; a dehumidifier; a water heater; a boiler controller; a pool pump; a refrigerator; a freezer; a television or computer monitor; a video camera; an amplifier; an elevator; a power supply; a generator; an electric charger, such as an electric vehicle charger, and an alternative energy controller.

The load control system 100 may comprise one or more input devices capable of receiving an input event for controlling one or more load control devices in the load control system 100. The input devices and the load control devices may be collectively referred to as control devices in the load control system 100. The input devices in the load control system 100 may comprise one or more remote control devices, such as remote control device 170. The remote control device 170 may be battery-powered or wired to power via a wiring installation in the wall. The remote control device 170 may be configured to transmit messages via the RF signals 108 to one or more other devices in the load control system 100 in response to an input event, such as an actuation of one or more buttons or a rotation of a rotary knob of the remote control device 170. The remote control device 170 may also be wired to other devices in the load control system, such as an intermediary device for transmitting signals in response to input events at the remote control device 170, and, in response to an input event, the intermediary device may transmit messages to one or more other devices in the load control system 100. For example, the remote control device 170 may comprise a keypad. In another example, the remote control device 170 may comprise a rotary knob configured to transmit messages via the RF signals 108 to one or more other devices in response to a rotation on the rotary knob (e.g., rotation of a predefined distance or for a predefined period of time). The remote control device 170 may be mounted to a structure, such as a wall, a toggle actuator of a mechanical switch, or a pedestal to be located on a horizontal surface. In another example, the remote control device 170 may be handheld.

The remote control device 170 may provide feedback (e.g., visual feedback) to a user of the remote control device 170 on a visual indicator, such as a status indicator. The status indicator may be illuminated by one or more light emitting diodes (LEDs) for providing feedback. The status indicator may provide different types of feedback. The feedback may include feedback indicating actuations by a user or other user interface event, a status of electrical loads being controlled by the remote control device 170, and/or a status of the load control devices being controlled by the remote control device 170. The feedback may be displayed in response to user interface event and/or in response to messages received that indicate the status of load control devices and/or electrical loads. Examples of battery-powered remote control devices are described in greater detail in commonly-assigned U.S. Pat. No. 8,330,638, issued Dec. 11, 2012, entitled WIRELESS BATTERY-POWERED REMOTE CONTROL HAVING MULTIPLE MOUNTING MEANS, and U.S. Patent Application Publication No. 2012/0286940, published Nov. 15, 2012, entitled CONTROL DEVICE HAVING A NIGHTLIGHT, the entire disclosures of which are hereby incorporated by reference.

One or more intermediary devices may also maintain association information that includes unique identifiers that make up associations between devices in the load control system 100. For example, the input devices and the load control devices may exchange unique identifiers or other association information and communicate on a communication link in the load control system 100 with each other directly or through one or more other intermediary devices. The intermediary devices may comprise input devices, load control devices, a central processing device, or another intermediary device capable of enabling communication between devices in the load control system. The association information that is maintained on the intermediary devices may comprise unique identifiers of the devices that are associated with one another for identifying and/or enabling communication of messages between devices in the load control system 100. For example, an intermediary device may identify the unique identifiers being transmitted in association messages between devices during an association procedure and store the unique identifiers of the devices as an association in the association information. The intermediary devices may use the association information for monitoring and/or routing communications on a communication link between devices in the load control system 100. In another example, the association information of other devices may be uploaded to the intermediary device and/or communicated from the intermediary device to the other devices for being locally stored thereon (e.g., at the input devices and/or load control devices).

The load control system 100 may comprise a system controller 110. The system controller 110 may operate as an intermediary device, as described herein. For example, the system controller 110 may operate as a central processing device for one or more other devices in the load control system 100. The system controller 110 may be operable to communicate messages to and from the control devices (e.g., the input devices and the load control devices). For example, the system controller 110 may be configured to receive messages from the input devices and transmit messages to the load control devices in response to the messages received from the input devices. The system controller 110 may route the messages based on the association information stored thereon. The input devices, the load control devices, and the system controller 110 may be configured to transmit and receive the RF signals 108 and/or over wired communication link.

The system controller 110 may receive information in messages from devices in the load control system 100 (e.g., inputs from input devices) via the RF signals 108 and generate corresponding control instructions for performing control at one or more load control devices.

For example, the system controller 110 may receive message(s) in response to a button press from the remote control device 170 and interpret these messages to generate control instructions based on control settings defined in the system configuration data of the load control system 100. The remote control device 170 may transmit a message via a wired or wireless communication link that indicates an actuation of a button to the system controller 110, which may receive the actuation and identify the button that was actuated to generate corresponding control instructions based on the control settings defined in the system configuration data of the load control system 100. The system controller 110 may then transmit messages to the load control device(s) for the load control devices to then control respective electrical loads. In another example, the system controller 110 may forward the inputs or control instructions received from the input devices to the load control devices. Thus, the input devices or the load control devices themselves may interpret the inputs to generate the control instructions, and the system controller 110 may route the messages based on the association information stored thereon. In other words, the input devices, the load control devices, as well as other devices in the load control system may communicate via the system controller 110. According to another and/or additional example, the input devices may directly communicate with the load control devices without the assistance of the system controller 110. The system controller 110 may still monitor such communications.

According to a further and/or additional example, the system controller 110 may originate and then communicate messages with input devices and/or load control devices. Such communications by the system controller 110 may include system configuration data (e.g., including control settings) for the control devices, such as configuring scene buttons on light switches. Communications from the system controller 110 may also include, for example, messages directed to load control devices and that include control instructions or commands for the load control devices to control respective electrical loads in response to the received messages. For example, the system controller 110 may communicate messages to change lighting intensity levels, to change lighting color settings, to change levels of the window fabric 152, to change HVAC settings, etc. Thus, the system controller 110 may operate as a control device or input device itself, by generating the control instructions thereon in response to one or more triggering events (e.g., timeclock events and/or other local triggering events) to send messages to the load control devices to control the corresponding electrical loads in the load control system 100.

The load control system 100 of FIG. 1A may be configured such that the system controller 110 is configured to communicate with a user device 190. The user device 190 may be a computing device executing software for enabling configuration and/or control of the devices in the load control system 100. The software may comprise instructions for controlling and/or configuring the load control system. The software may comprise installation guidance software configured to provide guided instructions to the user 192 to assist in installation of one or more devices in the load control system. The user device 190 may comprise a camera 191 configured to generate images thereon, which may be used to assist in configuration and/or control of the devices in the load control system 100.

The user device 190 may be local to the system controller 110, such that the two may directly communicate in a point-to-point fashion or through a local network specific to the user environment 102. It may be advantageous to allow the user 192 to communicate with the system controller 110 via the user device 190 and to control the load control system 100 from remote locations, such as via the Internet or other public or private network. Similarly, it may be advantageous to allow third-party integrators to communicate with the system controller 110 in order to provide enhanced services to users of user environment 102. For example, a third-party integrator may provide other systems within user environment 102. It may be beneficial to integrate such systems with load control system 100. In addition, the system controller 110 may be configured to communicate via the network with one or more other control systems (e.g., a building management system, a security system, etc.).

The system controller 110 may be configured to communicate via the network with the user device 190. The user device 190 may be a personal computing device, such as a laptop, a smart phone, and/or a tablet device. The user device 190 may be characterized by a unique identifier (e.g., a serial number or address stored in memory) that uniquely identifies the user device 190 and thus the occupant 192. The user device 190 may be configured to transmit messages to the system controller 110, for example, in one or more Internet Protocol packets and/or another wireless communication protocol (e.g., BLUETOOTH, etc.). For example, the user device 190 may be configured to transmit messages to the system controller 110 over a LAN and/or via the Internet. The user device 190 may be configured to transmit messages over the Internet to an external service, and then the messages may be received by the system controller 110 via that service. The user device 190 may transmit and receive RF signals 109. The RF signals 109 may be the same signal type and/or transmitted using the same protocol as the RF signals 108. Alternatively, or additionally, the user device 190 may be configured to transmit RF signals according to another signal type and/or protocol. The load control system 100 may comprise other types of computing devices coupled to the network, such as a desktop personal computer (PC), a wireless-communication-capable television, or any other suitable Internet-Protocol-enabled device. Examples of load control systems operable to communicate with mobile and/or computing devices on a network are described in greater detail in commonly-assigned U.S. Pat. No. 10,271,407, published Apr. 23, 2019, entitled LOAD CONTROL DEVICE HAVING INTERNET CONNECTIVITY, the entire disclosure of which is hereby incorporated by reference.

The load control system 100 may include a remote computing system 111 with which the system controller 110 and/or the user device 190 may be configured to communicate with the network. For example, the remote computing system 111 may communicate with the system controller 110 and/or the user device 190 via the Internet and/or RF signals 109. The remote computing system 111 may also or alternatively communicate with the system controller 110 and/or the user device 190 via a wired communication link.

The operation of the load control system 100 may be programmed and configured using, for example, the user device 190 or other computing device (e.g., when the user device is a personal computing device). The user device 190 may provide the user with access to a control/configuration application (e.g., via a graphical user interface (GUI)) for allowing a user 192 to program how the load control system 100 will operate and/or be controlled. For example, the control/configuration application may be executed as a local application on the user device 190 capable of communicating with other devices (e.g., remote computing system 111, system controller 110, and/or another remote computing device) via the user device 190, or as a remote application or service (e.g., executing on the remote computing system 111, the system controller 110, and/or another remote computing device) that is accessed via a local application (e.g., a web browser or other local application enabling a web interface). The control/configuration application, the system controller 110, and/or the remote computing system 111 (e.g., via instructions from the control/configuration application) may generate and/or store the system configuration data for enabling control of the devices in the load control system 100. The system configuration data may comprise a load control database that defines the operation of the load control system 100. Examples of configuration procedures for load control systems are described in greater detail in commonly-assigned U.S. Pat. No. 7,391,297, issued Jun. 24, 2008, entitled HANDHELD PROGRAMMER FOR A LIGHTING CONTROL SYSTEM; U.S. Patent Application Publication No. 2008/0092075, published Apr. 17, 2008, entitled METHOD OF BUILDING A DATABASE OF A LIGHTING CONTROL SYSTEM; and U.S. Pat. No. 10,027,127, published Jul. 17, 2018, entitled COMMISSIONING LOAD CONTROL SYSTEMS, the entire disclosure of which is hereby incorporated by reference.

The user device 190 may be used to update the system configuration data on which the load control system 100 operates. For example, the user 192 may request the system configuration data, or portions thereof, via the control/configuration application executing on the user device 190 for being displayed on the user device 190. The control/configuration application may request the system configuration data from one or more other devices in the load control system 100, such as the system controller 110 and/or the remote computing device 111. Upon receiving the information requests from the control/configuration application on the user device 190, the system controller 110 and/or the remote computing device 111 may respond by communicating the requested system configuration data to the user device 190. The control/configuration application on the user device 190 may also allow the user 192 to communicate messages to the system controller 110 and/or the remote computing device 111 to modify, edit, or change the system configuration data, such as a scene configurations stored therein, as further described herein.

The control/configuration application may include installation guidance software configured to guide the user 192 in installing and/or replacing one or more devices in the load control system. The user 192 may install or replace one or more of the input devices and/or load control devices in the load control system 100. For example, the input devices and/or the load control devices may be installed by an electrician or other professional trained in installing such devices, or the input devices and/or the load control devices may be installed by another user that is untrained in installing such devices in the load control system 100. Untrained users may need assistance in installing electrical devices in the load control system, such as electrical devices that may have to be wired to an electrical wall box, for example. Additionally, as the devices in the load control system 100 become more advanced and provide for a number of different electrical configurations, users may need assistance in installing such devices in the load control system. Installation of such devices may become even more difficult when the wires are disconnected from any device, the coloring of wires is confusing or inaccurate, and/or extra wires are installed in the wiring installation that the user 192 is accessing.

To assist the user 192 in the installation of the input devices and/or load control devices in the load control system 100, the user 192 may receive guided instructions on the user device 190. The guided instructions may be based on the specific device type of the input device and/or load control device being installed in the load control system 100 and/or on the specific type of device being uninstalled and replaced. The guided instructions may be generated or updated to accommodate uninstallation and/or installation of different types of devices. The guided instructions may be generated or updated to accommodate different wiring installations in the load control system (e.g., wiring installation in the wall box of the load control system). A wiring installation may include particular set of wires in wallbox that may be connected to and/or disconnected from a device.

The guided instructions may be provided to the user 192 on the user device 190. For example, the user device 190 may execute installation guidance software configured to provide the guided instructions (e.g., an installation guidance procedure) to the user 192 based on images received during installation. The installation guidance software may be executed locally on the user device 190 via a local app or application and/or may be executed on a remote computing device (e.g., the system controller 110 and/or the remote computing system 111) and provided to the user 192 via a local app or application executing on the user device 190. The user device 190 may receive images of the device being installed/uninstalled and/or the wiring installation and provide guided instructions specific to the device(s) and/or the wiring installation in the images. For example, the user device 190 may generate images of the device being installed and/or uninstalled and/or the wiring installation using the camera 191 on the user device 190. The images may be processed locally on the user device 190, or may be transmitted to another computing device (e.g., the system controller 110 and/or the remote computing system 111) for image processing. Based on the device(s) recognized in the images and/or the wiring installation identified in the images, the user device 190 or another computing device (e.g., the system controller 110 and/or the remote computing system 111) may generate the guided instructions for being provided to the user 192 via a display of the user device 190. The guided instructions may be provided as step-by-step instructions that are provided to the user 192 in response to the images generated by the camera 191.

The installation guidance software may include artificial intelligence (AI) or machine learning (ML) algorithms that are trained for detecting device characteristics for identifying devices in an image and/or wiring characteristics for identifying wires in an image. Based on the detected device characteristics and/or wiring characteristics, the installation guidance software may provide guided instructions specific to the device(s) and/or the wiring installation in the images. FIG. 1B is a schematic illustration of an example system environment 1101 for training and/or implementing an artificial intelligence and/or machine learning (AI/ML) model that comprises a neural network 1109 for detecting device characteristics for identifying devices in an image and/or wiring characteristics for identifying wires in an image. The neural network 1109 may comprise a feed forward neural network, a fully connected neural network, a convolutional neural network (CNN), a generative adversarial network (GAN), a recurrent NN (RNN), a residual NN (ResNet), and/or one or more other types of NNs. However, other types of AI/ML models (e.g., including neural networks and/or non-neural network models) may be similarly trained and/or implemented. The AI/ML model may be used to identify device characteristics and/or wiring characteristics from an image using a machine learning algorithm. The installation guidance software may automatically tag objects in the image based on the device characteristics and/or wiring characteristics identified by the AI/ML model (e.g., or devices or wires identified therefrom). For example, the installation guidance software may implement an AI/ML model that is trained on images comprising training data to identify the wiring characteristics, the device characteristics, and/or the characteristics of other objects in the image.

The neural network 1109 is an example of an AI/ML model that may be trained and/or implemented, as described herein. For example, the neural network 1109 may be trained and/or implemented on one or more devices to determine and/or update parameters and/or hyperparameters 1117 of the neural network 1109. Raw data may be generated from one or more sources. For example, the raw data may include image data generated by a camera or other device capable of generating images. The raw data may be processed (e.g., pre-processed) to generate training data 1107. The preprocessing may include formatting changes or other types of processing in order to generate the training data 1107 in a format for being input into the neural network 1109.

The neural network 1109 may include one or more layers 1111. The configuration of the neural network 1109 and/or the layers 1111 may be based on the parameters and/or hyperparameters 1117. The parameters may include weights, or coefficients, and/or biases for the nodes or functions in the layers 1111. The hyperparameters may include a learning rate, a number of epochs, a batch size, a number of layers, a number of nodes in each layer, a number of kernels (e.g., convolutional neural network (CNNs)), a size of stride (e.g., size of stride in CNNs), a size of kernels in a pooling layer (e.g., pooling layer in CNNs), and/or other hyperparameters. The neural network 1109 may be comprised of one or more different types of neural networks or different layers for different types of neural networks. For example, the neural network 1109 may include one or more individual layers having one or more configurations.

During the training process, the training data 1107 may include images or preprocessed data from the images that include one or more devices, device characteristics, wires, wiring characteristics, and/or wiring installations. The training data 1107 may be in an image format, a tensor format (e.g., including single-dimensional or multi-dimensional arrays), and/or another data type capable of being input into the neural network 1109. The training data 1107 may be input into the neural network 1109 and may be used to learn the parameters and/or tune the hyperparameters 1117 (e.g., learn the parameters and tune the hyperparameters). The training may be performed by initializing parameters and/or hyperparameters of the neural network 1109, generating and/or accessing the training data 1107, inputting the training data 1107 into the neural network 1109, calculating the error or loss from the output of the neural network 1109 to a target output 1115 via a loss function 1113 (e.g., utilizing gradient descent and/or associated back propagation), and/or updating the parameters and/or hyperparameters 1117. The loss function 1113 may be implemented using backpropagation-based gradient updates and/or gradient descent techniques, such as stochastic gradient descent, synchronous stochastic gradient descent, asynchronous stochastic gradient descent, batch gradient descent, and/or mini-batch gradient descent. Examples of loss or error functions may include functions for determining a squared-error loss, a mean squared error (MSE) loss, a mean absolute error loss, a mean absolute percentage error loss, a mean squared logarithmic error loss, a pixel-based loss, a pixel-wise loss, a cross-entropy loss, a log loss, and/or a fiducial-based loss. The loss functions may be implemented in accordance with one or more quality metrics, such as a signal-to-noise ratio (SNR) metric and/or another signal or image quality metric.

The training process may be iterated to update the parameters and/or hyperparameters 1117 until an end condition is achieved. The end condition may be achieved when the output of the neural network 1109 is within a predefined threshold of the target output 1115. After the training process is complete, the trained neural network 1109, or portions thereof, may be stored for being implemented by one or more devices (e.g., a system controller, a user device, etc.). The trained neural network 1109, or portions thereof, may be implemented in other downstream algorithms or processes. The trained neural network 1109, or portions thereof, may be implemented on the same device on which the training was performed. After the training process is complete, the trained parameters and/or tuned hyperparameters 1117, or portions thereof, may be stored for being implemented by one or more devices.

The parameters and/or tuned hyperparameters 1117 (e.g., the trained parameter and/or tuned hyperparameters), or portions thereof, may be implemented in other downstream algorithms or processes of the installation guidance software. For example, the trained parameters and/or tuned hyperparameters 1117 may be implemented by the installation guidance software to detect device characteristics/devices and/or wiring characteristics/wires from new images that are received, and the installation guidance software may provide the detected device characteristics/devices and/or wiring characteristics/wires to downstream algorithms or processes capable of providing instructions for uninstallation/installation of devices, as described herein. Though FIG. 1B shows one example of a model that may be trained or implemented, any number of models may be trained or implemented across any number of devices.

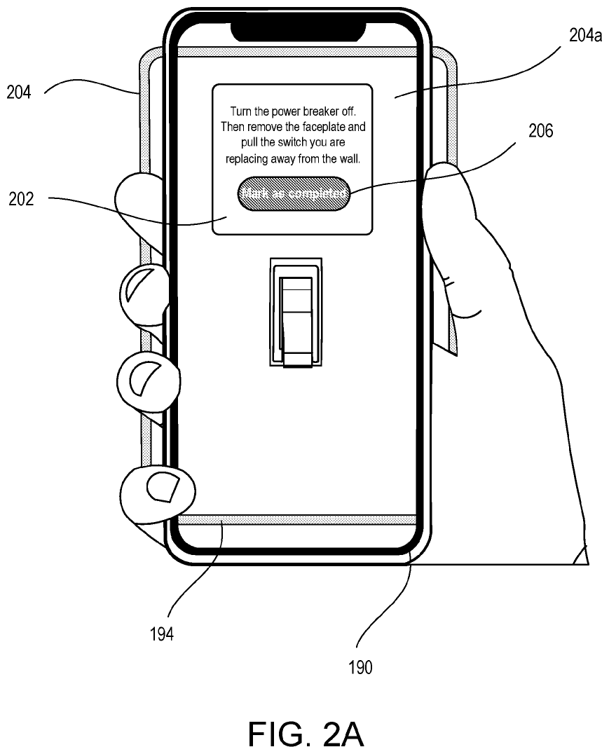

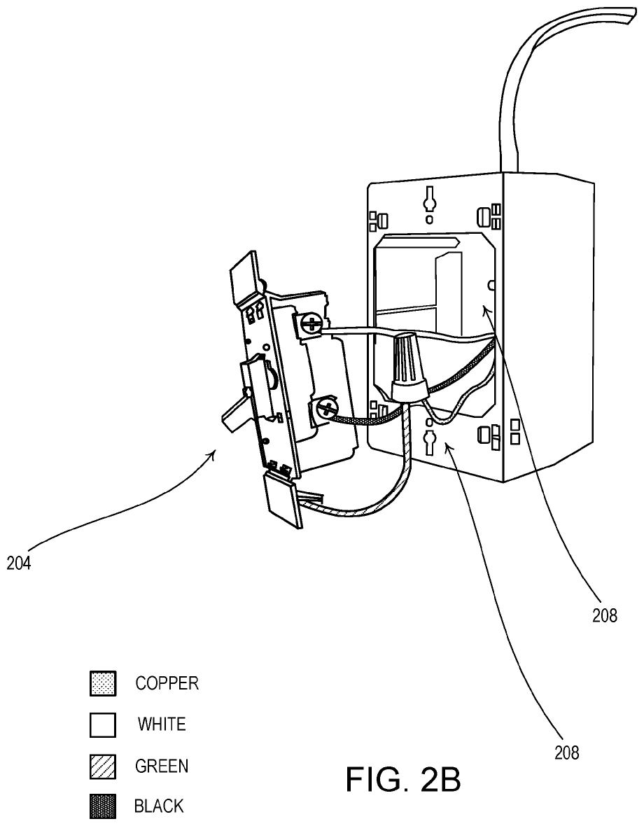

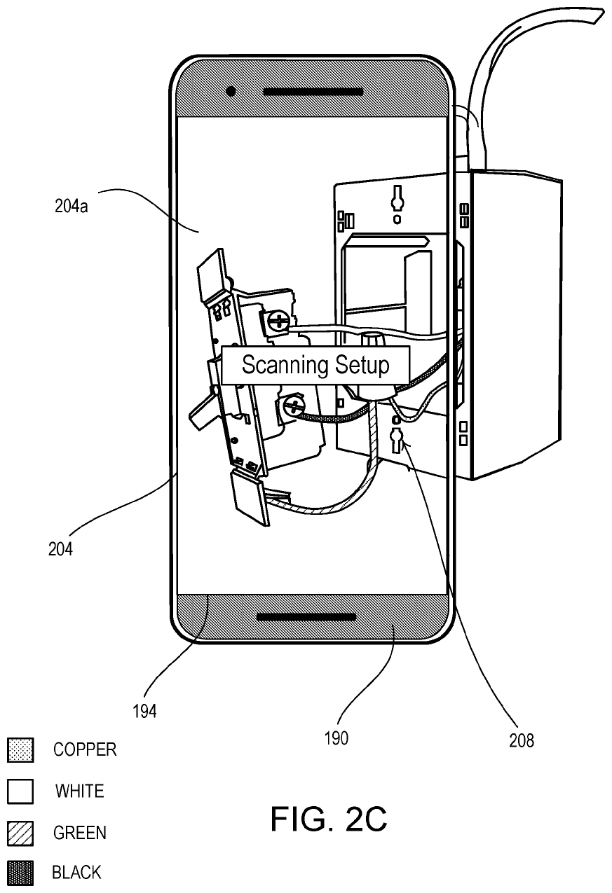

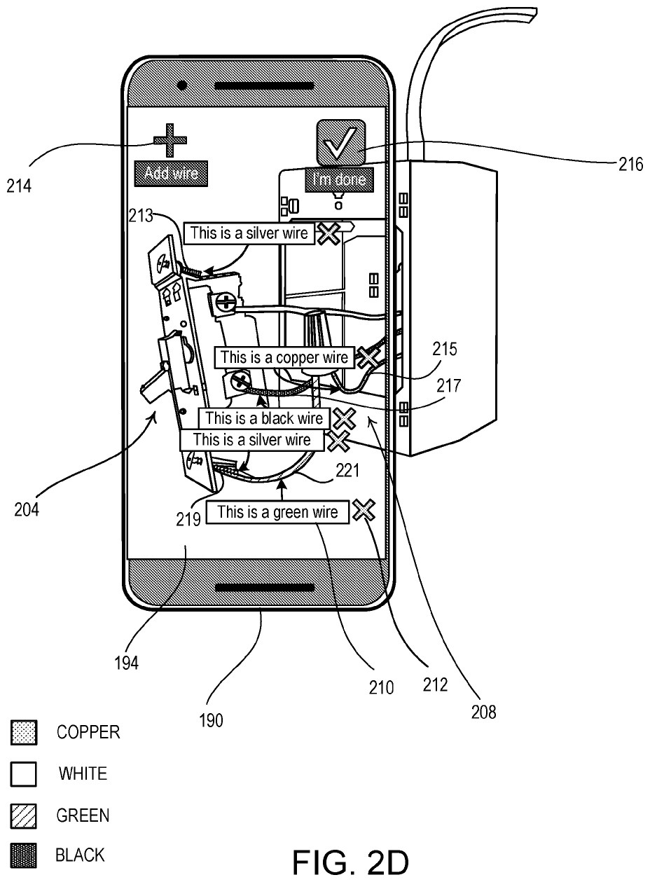

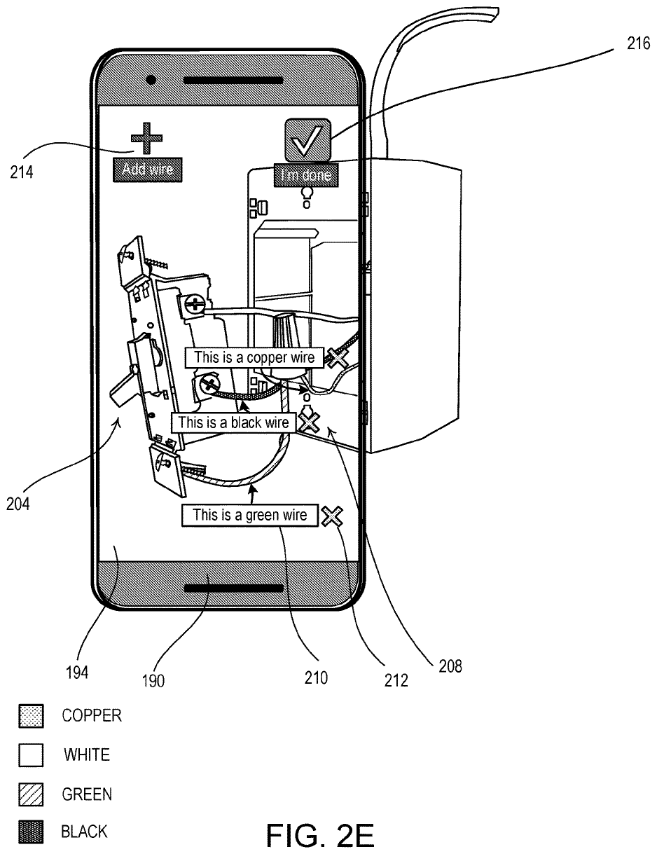

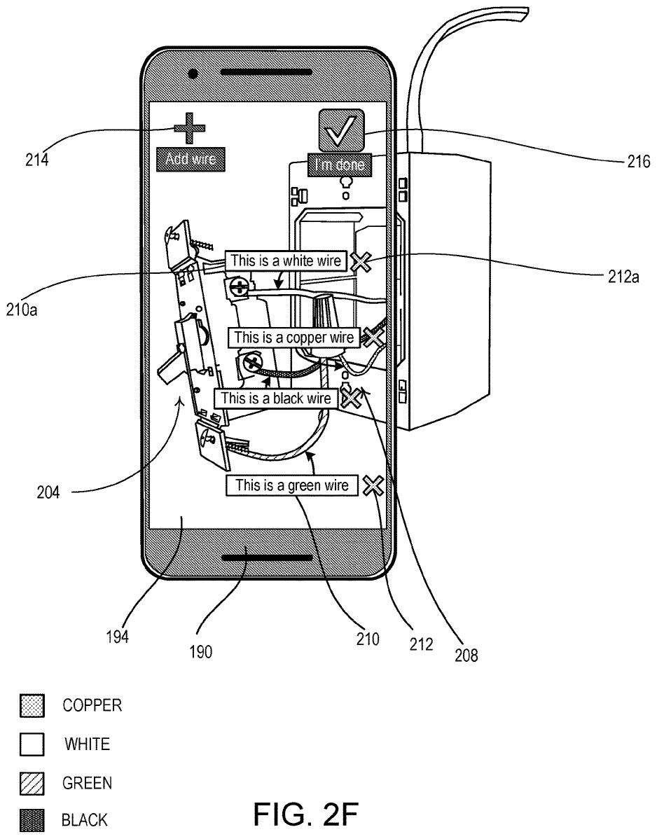

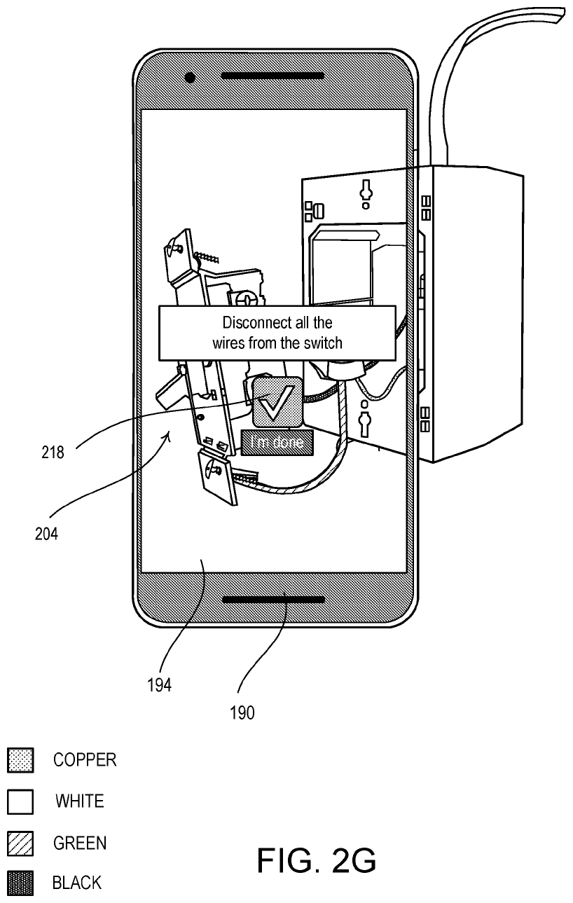

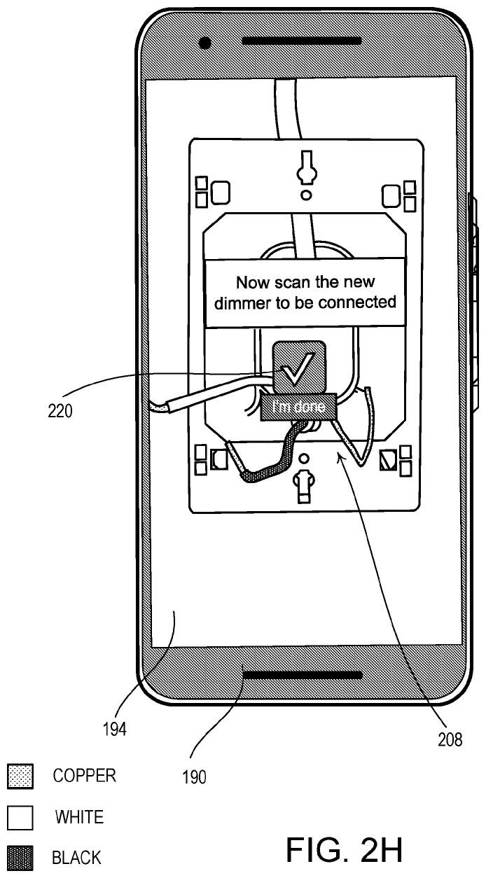

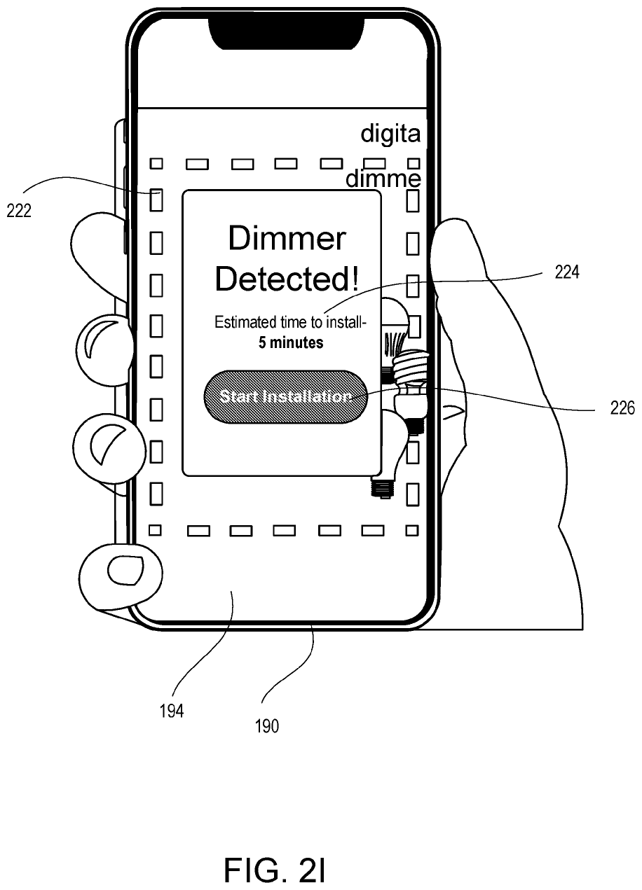

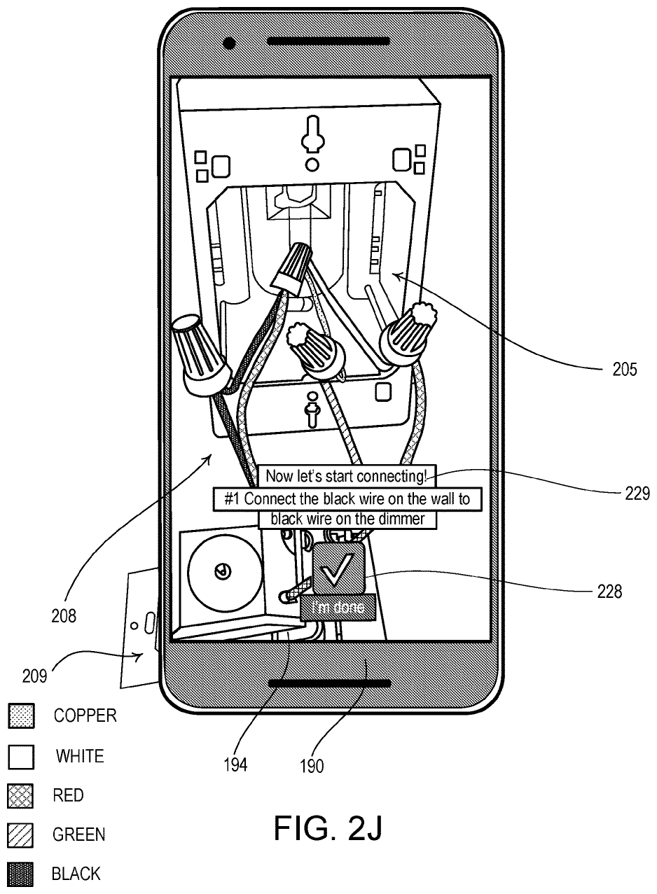

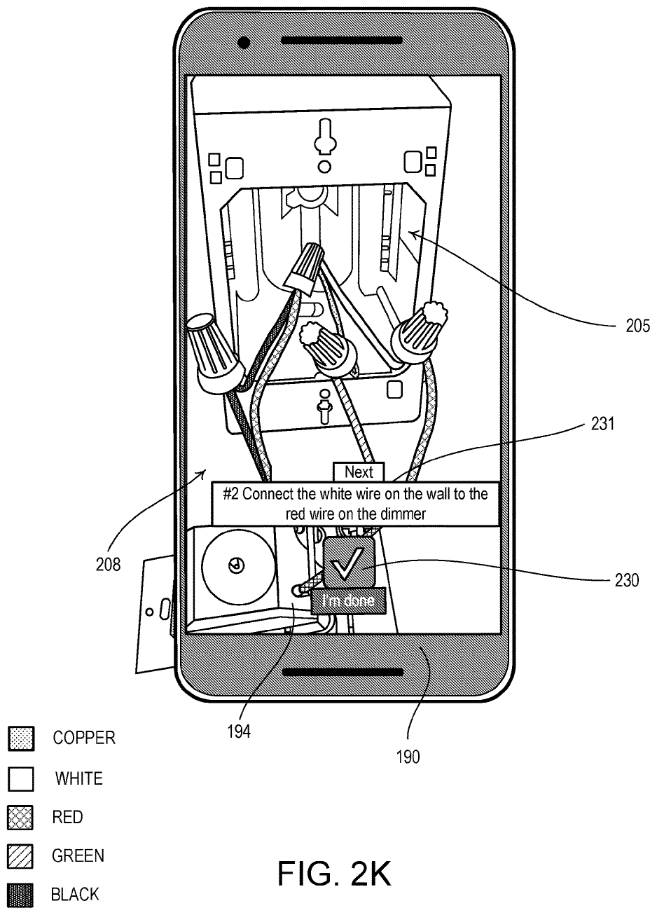

FIGS. 2A-2K show example graphical representations illustrating features of an example user interface that may be displayed by installation guidance software executed on a computing device(s) for providing guidance to a user installing a device in a load control system.

As shown in FIG. 2A, the user device 190 may display a prompt 202 to the user 192 on a display 194 of the user device 190 that provides an initial step in performing the installation. The prompt 202 may be provided after an actuation of a button on the user device 190 to provide the guided instructions. For example, the user 192 may indicate that the user 192 is performing an installation and/or an uninstallation of devices, or that the user 192 is just performing an installation of a device (e.g., in the case of an empty wallbox having no presently installed device). The selection by the user 192 may change the guided instructions that are provided via the user device 190. For example, the installation guidance software may instruct the user regarding an installation of a replacement device and/or an uninstallation of a presently installed device and an installation of a replacement device depending on the user input that is received.

The user 192 may actuate a button on the user device 190 to indicate that the user 192 is installing and/or uninstalling devices in the load control system 100 and the user device 190 may automatically identify the steps to provide in the guided instructions based on the images generated by the user device 190. For example, the user device 190 or another computing device (e.g., the system controller 110 and/or the remote computing system 111) may automatically detect the device(s) being installed/uninstalled from the images generated by the camera 191 on the user device 190. The user 192 may similarly indicate the device(s) being installed and/or uninstalled manually via input to the user device 190.

As shown in FIG. 2A, the user device 190 may display the prompt 202 instructing the user 190 to uninstall the switch 204 from the wall. The user device 190 may display an image 204a of the switch 204 that is generated by the camera of the user device 190. The switch 204 may include the switch itself and/or the faceplate. The prompt 202 may be overlaid on top of the image 204a. The prompt 202 may also provide a reminder to the user 192 to cut off power to the switch 204 being uninstalled. Once the user 192 completes the step on the prompt 202, the user may actuate the button 206 indicating that the step on the prompt 202 has been completed. The user device 190 may display the next step in the guided instructions in response to the user actuation of the button 206. Though the switch 204 is provided as an example device for which guided instructions for uninstallation may be provided, similar guided instructions may be provided for uninstalling other input devices, load control devices, and/or other devices in the load control system 100.

After the user 192 removes the faceplate from the switch 204 and unmounts the switch 204 from a wallbox, the user 192 may expose an existing wiring installation, such as an existing wiring installation 208 shown in FIG. 2B. The existing wiring installation 208 may be a 2-wire installation, a 3-wire installation, a 4-wire installation, or another wiring installation. The switch 204 may be wired to the existing wiring installation 208 in the wall, such that the wires in the installation are connected to the terminals or wires of the switch 204 to create the configuration of the wiring installation as connected at the switch 204. When the user 192 looks at the present wiring installation 208 and/or the configuration of the wiring installation as connected at the switch 204, the user 192 may need guidance as to the proper wires to connect to a replacement lighting control device or other device that is being installed. The user 192 may be unsure of the proper wires in the wiring installation 208 to connect to the replacement lighting control device or other device that is being installed. The installation may be even more confusing when the wires in the wiring installation 208 are not clearly differentiated or familiar to the user. For example, the wires in the wiring installation 208 may not be color coded in a manner in which the user is familiar or the wires may have the same or similar color, etc.

As shown in FIG. 2C, the user 192 may use the user device 190 to recognize one or more wires in the wiring installation 204 to be used in installing another device in the load control system 100. For example, the camera 191 of the user device 190 may be pointed by the user in the direction of the switch 204 and/or the wiring installation 208. The user device 190 may generate images 204a of the switch 204 and/or the wiring installation 208. The user device 190, or another computing device (e.g., system controller 110 and/or remote computing system 111), executing the installation guidance software may analyze the images to detect wiring characteristics and/or device characteristics of the current installation in the images. For example, the installation guidance software may utilize trained AI/ML algorithms and/or another algorithm to detect wiring characteristics and/or device characteristics, as described herein.

The wiring characteristics that may be identified in the images may include a color of a covering material (e.g., insulation) of the wire(s), a thickness of the covering material of the wire(s), a type of exposed end of the wire coming out of the covering material, a gauge of the wire, a location or color of a terminal to which the wire is connected to a presently installed device, a wire length (e.g., length of wire visible in image from wallbox or other length of wire), and/or other wiring characteristics. Bare copper wires, wires failing to have a covering material, and/or green wires may be identified as ground wires. Wires having a white or gray covering material may be identified as neutral wires. Wires having a black or red covering material may be identified as hot wires. Wires having a black or red covering may also, or alternatively be identified as traveler wires or hot wires. Wires having a covering material with a thickness identified above a threshold may be identified as hot wires and/or traveler wires. Wires having a covering material with a thickness identified below a threshold may be identified as neutral wires. Wires having a gauge below a threshold may be identified as a ground wire. Wires having a gauge above the threshold may be identified as hot, neutral, or traveler wires. The type of the exposed end may be detected by the texture of the exposed end of the wire. Different exposed ends may have a different texture based on whether the wire is a low-voltage wire or a high-voltage wire. The higher-voltage wire may be identified for carrying power or be identified as the hot wire.

The device characteristics that may be identified in the images may include a terminal color (e.g., terminal screw color), a terminal location (e.g., terminal screw location), a number of terminals (e.g., number of terminal screws), and/or other device characteristics. A terminal screw having a darker color than other terminal screws or a black color may be identified as a common terminal, a hot terminal, or a dimmed-hot terminal. A terminal screw having a lighter color than the common terminal or a brass color may be identified as traveler terminals or hot terminals. A screw having a green color may be identified as a ground screw. The number of terminals may be used to identify the type of device being wired. For example, a single-pole switch may be identified as having two brass terminal screws of the same color and a ground screw of another color or material. A double-pole switch may be identified as having four brass terminal screws and one ground screw. A three-way switch may be identified as having three terminal screws (e.g., a darker or black terminal screw as common and two lighter or brass terminal screws) and a ground screw. A four-way switch may be identified as having four terminal screws (e.g., two lighter or brass terminal screws and two darker or black terminal screws) and a ground screw. Some switches may also have a neutral connection for connecting a neutral wire. The neutral connection or terminal screw may be identified as having a silver color. Though switches are provided as examples, it will be understood that switches may comprise on/off switches, dimmer switches, or another type of switch. Other electrical devices may similarly be connected as described herein and the device characteristics may be similarly identified for providing guided instructions. Additionally, though terminal screws are used as examples of device characteristics, the devices may also, or alternatively, have wires extending from the back of the device that may be identified based on the wire characteristics coming from the device. In another example, devices may have stab-in connections that may be identified from the images. Furthermore, wiring characteristics above may similarly be used as device characteristics for establishing connections where the device has wires extending therefrom.

Referring now to FIG. 2D, the installation guidance software operating on the user device 190 and/or another device (e.g., the system controller 110 and/or the remote computing system 111) may identify the wires that are connected to the switch 204 using the wiring characteristics and/or the device characteristics. As shown in FIG. 2D, the installation guidance software may identify a first silver wire 213, a copper wire 215, a black wire 217, a second silver wire 219, and a green wire 221. The identified wires may be tagged in the images and stored in memory for use in providing guidance when installing other devices in the load control system. A tagging of an object in an image may associate the identified object in the image and/or characteristics thereof with predetermined descriptors. Objects may be tagged with a location in the image and/or other characteristics. Tagged wires or devices may be stored in memory with the wiring characteristics and/or device characteristics that may be used to provide the subsequent guidance for installing other devices. The installation guidance software may display a descriptor 210 and/or other indicator of each of the tagged wires identified by the installation guidance software, which may also be stored in memory with the tag.

The installation guidance software may use image recognition (e.g., trained AI/ML algorithms) to automatically tag objects in the images. For example, the installation guidance software may implement a linear regression algorithm or a neural network that is trained on images in training data to identify the wiring characteristics, the device characteristics, and/or the characteristics of other objects in the image.

The installation guidance software may allow for user input to update the tags for the wires that have been automatically identified for wiring installation by the installation guidance software. For example, the installation guidance software may allow for the user 192 to add or remove tags before proceeding to the next step of the installation guidance procedure. The installation guidance software may display a tag removal actuator 212 that may be actuated by the user 192 to remove the tag from the object in the image. A tag removal actuator 212 corresponding to each tagged object may be displayed next to the object in the image and/or the descriptor 210. The actuation of the tag removal actuator 212 for a tagged object in the image may de-tag the object by removing the tagging from memory. The de-tagging of the object may cause the installation guidance software to remove the display of the corresponding descriptor 210 or other indicator of the tagged object from the display. The de-tagging of the object may remove the descriptor of the wire, the wiring characteristics, and/or the association of the wiring characteristics from memory. By de-tagging the object, the installation guidance software may ignore the object when providing installation guidance instructions to the user.

As shown in FIG. 2D, the installation guidance software may mistakenly identify portions of the switch 204 as wires or other object. For example, as shown in FIG. 2D, the installation guidance software may mistakenly identify screws as a silver wire (e.g., the first silver wire 213 and the second silver wire 219). The user 192 may use the respective tag removal actuators 212 to remove the tagging of these portions of the switch 204. The user 192 may actuate the respective tag removal actuator 212 corresponding to the mistakenly tagged silver wires (e.g., the first silver wire 213 and/or the second silver wire 219). The tagging of the object may be removed from memory in response to the actuation of the respective tag removal actuator 212. Referring now to FIG. 2E, the installation guidance software may remove the tag removal actuator 212 and/or the descriptor 210 corresponding to the tagged silver wires in the displayed image on the display 194 of the user device 190.

The installation guidance software may allow for the user 192 to update a descriptor stored for a tagged object in the images. For example, the descriptor may be automatically determined and/or may be incorrectly stored in memory for a tagged wire. The user may select the incorrectly tagged object and update the descriptor (e.g., change descriptor color or other element of the descriptor).

The installation guidance software may allow for the user 192 to add tags to objects in the images using an add tag actuator 214 before proceeding to the next step of the installation guidance procedure. The installation guidance software may display the add tag actuator 214, which may be actuated by the user 192 to add a tag to an object in the image. For example, the installation guidance software may mistakenly fail to identify one or more wires in the image.

As shown in FIG. 2E, the installation guidance software failed to identify a white wire (e.g., a neutral wire) in the image. The user 192 may actuate the add tag actuator 214 and select the white wire in the image to tag the wire. Based on the user input in the location of the image on the display 194, the installation guidance software may identify the white wire in the image, or the location of the wire, and tag the wire and/or the selected location of the wire in memory. The user 192 may be prompted to enter a descriptor 210 or other indicator for the added tag. The descriptor may be entered into a text box or selected from a predefined list of descriptors. Referring now to FIG. 2F, the installation guidance software may display the descriptor 210a for the tag that has been added to the image. The installation guidance software may also, or alternatively, display a tag removal actuator 212a corresponding to the tagged white wire in the displayed image. The tagged wires that have been added may be included in the installation guidance procedure that is provided to the user 192. The tagged wires that have been removed may fail to be considered in the installation guidance procedure that is provided to the user 192. Each of the tagged objects may be considered to determine the purpose of each object by the installation guidance software to determine the proper instructions for installing replacement devices.

The updates to the tags may be used to improve the AI/ML algorithm or other algorithm to better detect objects in images based on the tags that are added or removed from the images. For example, the machine learning algorithm may be trained to identify objects that failed to be recognized in the image based on the added tags and/or to avoid tagging objects that have the tags removed by the user 192.

After the appropriate wires in the image have been tagged, the user 192 may actuate the button 216 to go to the next step of the installation guidance procedure. For example, the installation guidance software may provide guidance on uninstalling the currently-installed device and/or installing a replacement device. The steps or instructions that are provided by the installation guidance software may be determined based on the descriptor, the wiring characteristics, and/or the device characteristics that have been determined. For example, the installation guidance software may determine from the device to be installed and/or the wiring characteristics/descriptor for each of the wires that have been tagged, the proper steps to be provided via the display of the user device.

As shown in FIG. 2G, the installation guidance software may prompt the user 192 to disconnect the wires from the switch 204. The user 192 may select the actuator 218 to go to the next step of the guided installation. At this point, the installation guidance software may have identified the purpose of each of the identified objects, and/or the purpose of each of the identified wires (e.g., hot, common, neutral, traveler, etc.), for being able to provide instructions on how to connect the identified wires to a replacement device.

FIG. 2H shows an example of the mobile device 190 generating an image and displaying the image on the display 194 that shows the wiring installation 208 after the wires have been disconnected from the switch 204. The user 192 may disconnect the switch 204 or another device during the installation guidance procedure that is being provided by the installation guidance software, or the user 192 may have already disconnected the switch 204 or another device that is being replaced before scanning the wiring installation 208 with the camera 191 of the user device 208 during execution of the installation guidance software. If the user 192 has already disconnected the switch 204 from the wiring installation 208 before executing the installation guidance software to capture images of the wires when they were previously connected to a switch, the installation guidance software may begin by scanning the wiring installation 208 and using the wiring characteristics to identify the wires to be connected to a device that is being installed. The tagging of the wires in the wiring installation 208 may be performed and/or updated as described herein. For example, the installation guidance software may scan the images and tag the wiring characteristics identified for each wire with a descriptor. The descriptor may be automatically determined based on the wiring characteristics or input by the user. The user may update the descriptors of tagged wires, de-tag wires, and/or add tagged wires. The tagged objects may be used for subsequent execution of the installation guidance procedure and prompts for providing the installation guidance procedure to the user 192.

As shown in FIG. 2H, the installation guidance software may prompt the user 192 to scan the device to be installed. The user 192 may select the actuator 220 to scan the device to be installed. For example, as shown in FIG. 2I, the user 192 may point the camera 191 of the user device 190 at the device or the device packaging to automatically identify the device being installed from the images generated by the camera 191. The installation guidance software may identify the device from the device characteristics or identifiers on the packaging of the device. For example, the device or device packaging may have a unique identifier, bar code, QR code, or other identifier capable of being identified by the installation guidance software from the images generated by the camera 191. The installation guidance software may display an outline 222 within which the device or device packaging should be displayed for recognizing the device. The installation guidance software may determine (e.g., from the device type and/or the wiring installation) an estimated time for install and provide the estimated time via the display 194. When the device is identified, the installation guidance software may display a prompt 224 to the user 192 indicating that the device has been detected. The user 192 may also, or alternatively, manually enter a device identifier (e.g., product name, unique device serial number, or other device identifier) for receiving the installation guidance procedure on the device. The device identifier may be entered via text or selected from list of devices (e.g., devices by type and/or manufacturer). After the device has been identified, the user 192 may select the actuator 226 to receive the installation guidance procedure for the selected device. Once the device is identified, the installation guidance software may determine how the device is configured. For example, the installation guidance software may determine the terminal screws, wires, and/or other components on the identified device to which the wires in the wiring installation may be connected. The installation guidance software may determine a location of the terminal screws, wires, and/or other components of the identified device to which the wires in the wiring installation may be connected. The components and/or the location of the components may be stored in a dataset by device type. The installation guidance software may determine based on the components of the identified device and the wiring installation how to connect the wires in the wiring installation 208 to the identified device. The installation guidance software may determine the steps indicating how to connect the wires in the wiring installation to the identified device dynamically and/or select the steps from predetermined steps available for the installation guidance procedure.

The installation guidance procedure may be provided as step-by-step instructions based on the identified device and the wiring installation that was previously identified. For example, the installation guidance procedure may be different for a 2-wire dimmer and a 3-wire dimmer. The installation guidance procedure may even be different for devices of the same type, but having different manufacturers. For example, some devices may have a neutral wire connected to the device as a part of the installation, while other devices of the same type may not have the neutral wire connected during installation. The configuration of the wiring installation as connected at the switch for the identified device may be stored in memory and be accessible by the installation guidance software.

The installation guidance procedure may provide step-by-step instructions for installation of the identified device using the wires in the wiring installation 208. For example, as shown in FIGS. 2J and 2K, the installation guidance software may display a prompt for each tagged wire to be connected to a wire or terminal (e.g., terminal screw) on the device being connected. In FIGS. 2J and 2K, a dimmer switch 209 is being installed and the installation guidance software displays a prompt 229 providing instructions for connecting each wire on the dimmer with each wire in the wiring installation 208. As shown in FIG. 2J, the installation guidance software displays a prompt 229 instructing the user 192 to connect the black wire on/from the wall/wallbox 205 to the black wire on the dimmer. As shown in FIG. 2J, the dimmer that is being installed has flying leads and/or wires for connecting with the wiring installation coming from the wallbox. The installation guidance software may display a different prompt or instruction to the user 192 for installing a dimmer with screw terminals or other types of devices. The user 192 may actuate an actuator 228 to indicate to the installation guidance software that the step is complete and to cause the installation guidance software to show the next step in the installation guidance procedure. As shown in FIG. 2K, the installation guidance software may display a prompt 231 next instructing the user 192 to connect the white wire on/from the wall/wallbox to the red wire on the dimmer. The user 192 may actuate an actuator 230 to indicate to the installation guidance software that the step is complete and to cause the installation guidance software to show the next step in the installation guidance procedure. The user 192 may continue being instructed by the installation guidance software as to the wire connections to make based on the device being installed and the wiring installation 208 until the installation is complete. Though the installation instructions are provided in a series of steps with an actuator for showing the next step in the instructions, the installation guidance software may display the steps of the installation guidance procedure on a single page, provide multiple steps on one or more pages, or otherwise display the instructions to the user 192.

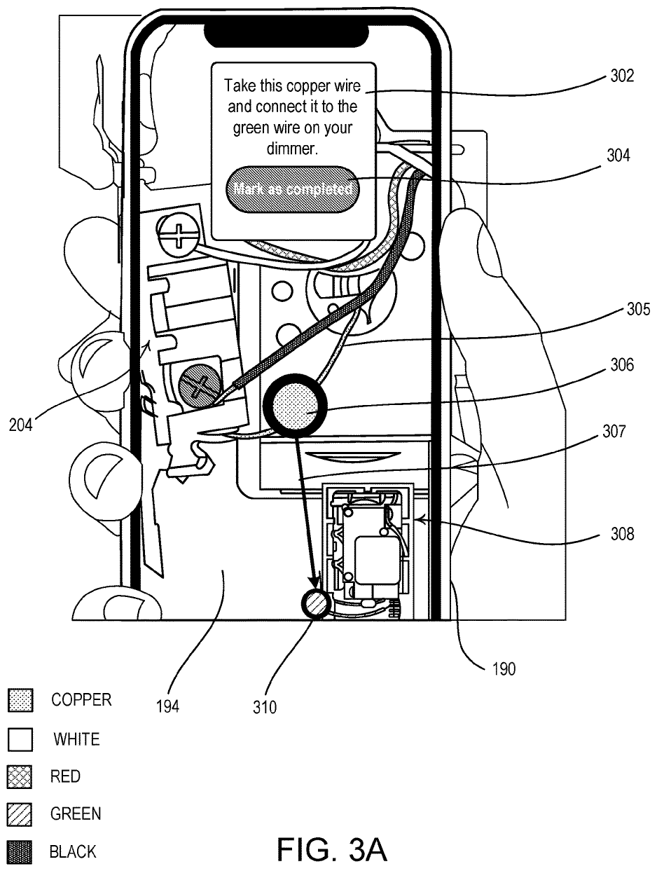

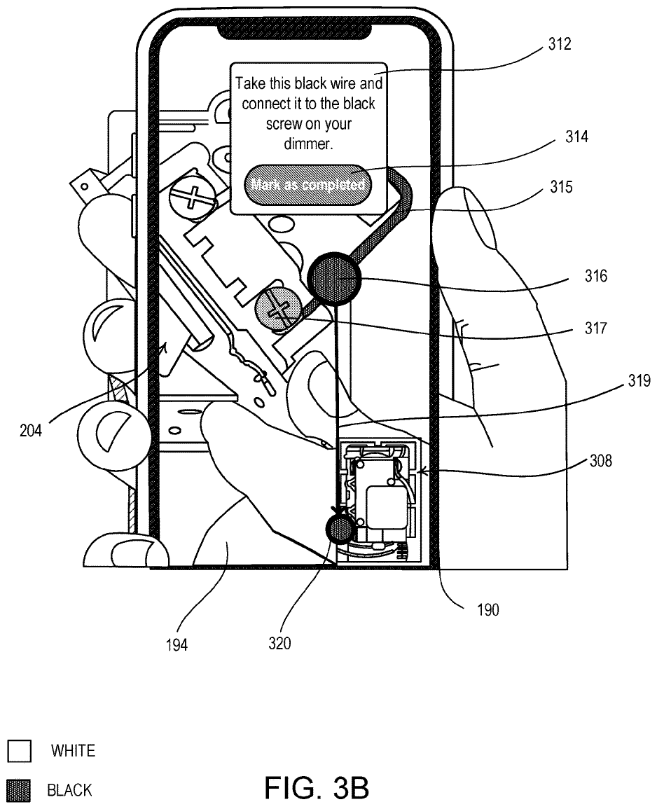

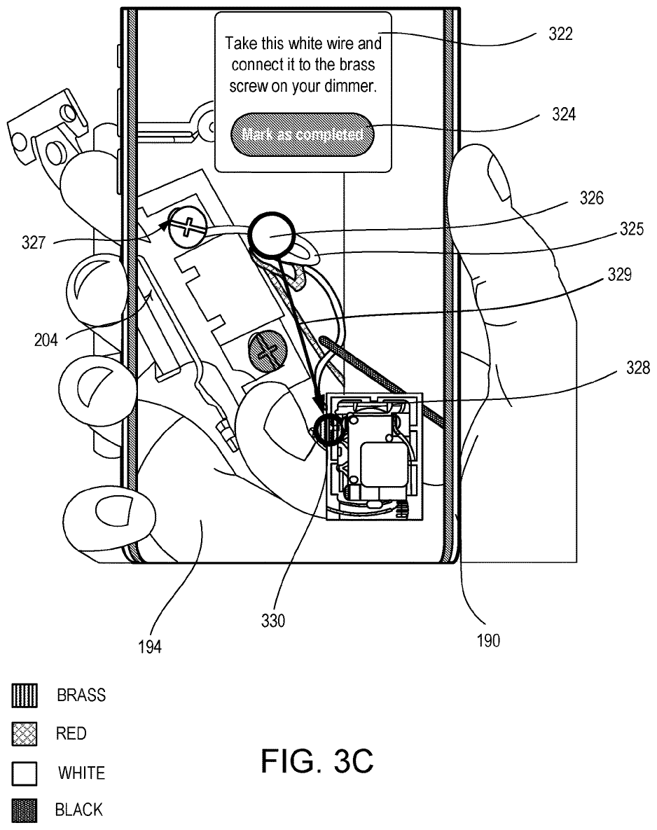

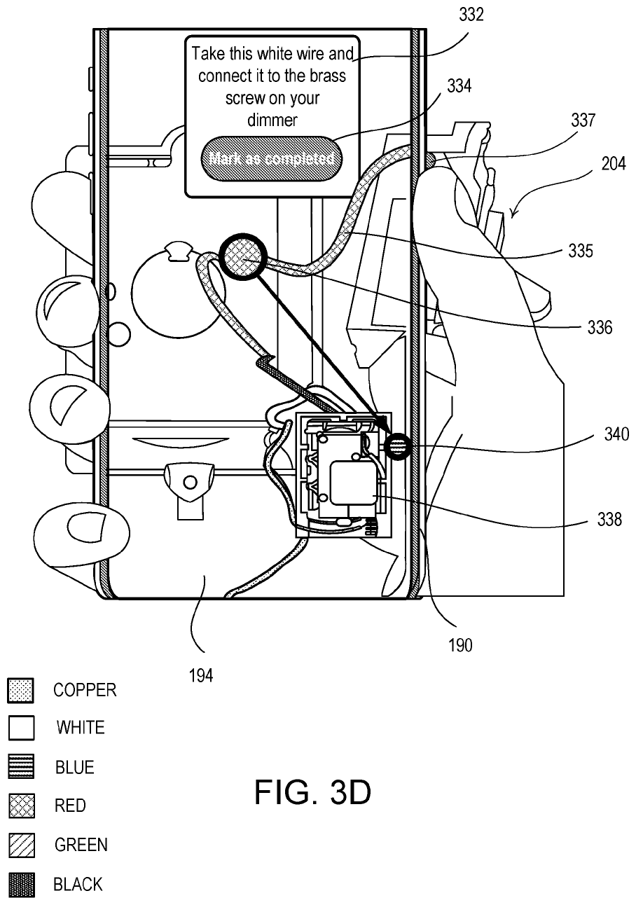

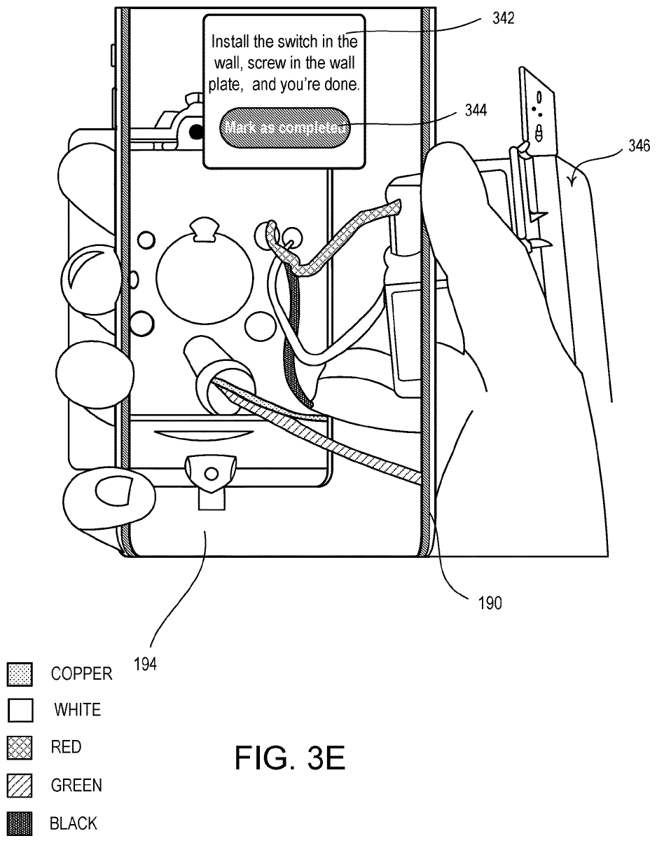

FIGS. 2J-2K show an installation guidance procedure in step-by-step instructions for connecting each of the wires to the device being installed after the wires have already been disconnected from the currently-installed device. FIGS. 3A-3E show another example for a step-by-step installation guidance procedure for removing each wire from the device that is currently installed and moving the wire to a location on the replacement device being installed. The installation guidance procedure shown in FIGS. 3A-3E may similarly be generated by the installation guidance software based on the device characteristics of the currently-installed device and/or the wiring characteristics of the wiring installation and the replacement device being installed. The installation guidance procedure shown in FIGS. 3A-3E may also be provided after the installation guidance software has identified the device being installed in place of the currently installed device, as described herein.

As shown in FIG. 3A, the installation guidance software may identify a wire 305 that is attached to the currently-installed switch 204 that is currently installed based on the wire 305 and/or the switch 204, as described herein. The installation guidance software may instruct the user as to the location that the wire 305 should be attached on the device being installed. For example, the wire 305 may be the ground wire. The installation guidance software may display a prompt 302 on the display 194 of the user device 190 that provides instructions to the user 192 for properly connecting the wire 305 to the replacement device. The installation guidance software may determine the location at which to connect the wire 305 to the replacement device and display the location to the user on the display 194. The installation guidance software may display an indicator 306 (e.g., circle) that identifies the wire 305 (e.g., the tagged wire).

The installation guidance software may overlay an image 308 of the device being installed to assist the user 192 in identifying the location to attach the wire 305 on the device being installed. The image 308 may be displayed from stored images of one or more switches, dimmers, or other devices. The installation guidance software may display an indicator 310 on the image 308 that identifies a location to attach the wire 305 on the replacement device being installed. The indicator 306 may display a color that corresponds to the wire 305 (e.g., tagged wire) being detached from the currently-installed device and being connected to the replacement device being installed. For example, the indicator 306 may be colored copper to indicate the wire 305 (e.g., ground wire) that is being removed and attached to the replacement device. The indicator 310 may display a color that corresponds to the location to which the wire 305 (e.g., tagged wire) is to be installed on the replacement device. For example, the indicator 310 may be colored green to indicate the color of the ground screw or wire on the replacement device. The color of the indicators 306, 310 may assist the user in tracking the wire that has been disconnected from the switch 204 and/or the corresponding location on the replacement device during the installation process. Though the colors of the indicators 306, 310 may be different, the colors may alternatively be the same to show a correspondence between the wire and the device location for being installed. In another example, the installation guidance software may additionally or alternatively draw a line 307 on the image being displayed or provide another indication of the correspondence between the wire 305 and the location to which the wire is to be connected on the replacement device being installed, as shown in FIG. 3A. An association between the wire 305 (e.g., tagged wire) and the location to be installed on the replacement device may be stored in memory and may be retrieved for being provided to the user on the display 194. The installation guidance software may identify an object (e.g., object identified as a wire that is not a wire, as shown in FIG. 2D) and skip the installation of that object when providing the installation guidance instructions.

The installation guidance software may display an actuator 304 (e.g., on the prompt 302 on the display 194 of the user device 190). The actuator 304 may be actuated after the user 192 has installed the wire 305 on the replacement device to indicate to the installation guidance software that the step is complete. After the user 192 actuates the actuator 304, the installation guidance software may provide the next step of the installation guidance procedure.

As shown in FIG. 3B, the installation guidance software may provide instructions for disconnecting the wire 315 (e.g., the next wire) from the switch 204 that is currently installed and connecting the wire 315 to the replacement device being installed. For example, the wire 315 may be a black wire that is identified as the hot wire carrying power to a common terminal screw 317 on the switch 204. The installation guidance software may display a prompt 312 on the display 194 of the user device 190 that provides instructions to the user 192 for properly connecting the wire 315 to the replacement device. The installation guidance software may determine the location at which to connect the wire 315 to the replacement device and display the location to the user on the display 194. The installation guidance software may display an indicator 316 (e.g., a circle) that identifies the wire 315 (e.g., the tagged wire).

The installation guidance software may display an indicator 320 on the image 308 of the device being installed that identifies a location to attach the wire 315 on the replacement device being installed. Though the image 308 (e.g., the same image as shown in FIG. 3A) may be provided as an example of an image that may be overlayed for assisting the user with identifying the locations to attach wires on the replacement device, the installation guidance software may overlay different images for attaching different wires to the replacement device to provide a different perspective for attachment of a given wire. The images may be accessed in a database or other storage of available images of one or more devices. The indicator 316 may display a color that corresponds to the wire 315 (e.g., the tagged wire) being detached from the currently installed device and being connected to the replacement device being installed. For example, the indicator 316 may be colored black to indicate the wire 315 (e.g., the hot wire) that is being removed and attached to the replacement device. The indicator 320 may display a color that corresponds to the location to which the wire 315 (e.g., the tagged wire) is to be installed on the replacement device. For example, the indicator 320 may be colored black to indicate the color of the common terminal screw 317 or wire on the replacement device. The color of the indicators 316, 320 may assist the user in tracking the wire that has been disconnected from the switch 204 and the corresponding location of the replacement device during the installation process. In another example, the installation guidance software may alternatively and/or additionally draw a line 319 (as shown in FIG. 3B) on the image being displayed or provide another indication of the correspondence between the wire 315 and the location to which the wire is to be connected on the replacement device being installed. An association between the wire 315 (e.g., the tagged wire) and the location to be installed on the replacement device may be stored in memory and may be retrieved for being provided to the user on the display 194.

The installation guidance software may display an actuator 314 (e.g., on the prompt 312 on the display 194 of the user device 190). The actuator 314 may be actuated after the user has installed the wire 315 on the replacement device to indicate to the installation guidance software that the step is complete. After the user 192 actuates the actuator 314, the installation guidance software may provide the next step of the installation guidance procedure.

As shown in FIG. 3C, the installation guidance software may provide instructions for disconnecting the wire 325 (e.g., the next wire) from the switch 204 that is currently installed and connecting the wire 325 to the replacement device being installed. For example, the wire 325 may be a white wire that is identified as a second hot wire connected to a terminal screw 327 on the switch 204. The installation guidance software may display a prompt 322 on the display 194 of the user device 190 that provides instructions to the user 192 for properly connecting the wire 325 to the replacement device. The installation guidance software may determine the location at which to connect the wire 325 to the replacement device and display the location to the user on the display 194. The installation guidance software may display an indicator 326 (e.g., a circle) that identifies the wire 325 (e.g., the tagged wire).

The installation guidance software may display an indicator 330 on the image 308 that identifies a location to attach the wire 325 on the replacement device being installed. The indicator 326 may display a color that corresponds to the wire 325 (e.g., the tagged wire)being detached from the currently installed device and being connected to the replacement device being installed. For example, the indicator 326 may be colored white to indicate the wire 325 (e.g., the second hot wire) that is being removed and attached to the replacement device. The indicator 330 may display a color that corresponds to the location to which the wire 325 (e.g., the tagged wire) is to be installed on the replacement device. For example, the indicator 330 may be colored brass to indicate the color of the terminal screw 327 on the replacement device. The color of the indicators 326, 330 may assist the user in tracking the wire that has been disconnected from the switch 204 and the corresponding location on the replacement device during the installation process. Though the colors of the indicators 326, 330 may be different, the colors may alternatively be the same to show a correspondence between the wire and the device location for being installed. In another example, the installation guidance software may alternatively and/or additionally draw a line 329 on the image being displayed or provide another indication of the correspondence between the wire 325 and the location to which the wire is to be connected on the replacement device being installed. The wire 325 (e.g., the tagged wire) may be stored in memory with a location to be installed on the replacement device, which may be retrieved and provided to the user on the display 194.

The installation guidance software may include an actuator 324 (e.g., on the prompt 322 on the display 194 of the user device 190). The actuator 324 may be actuated after the user has installed the wire 325 on the replacement device to indicate to the installation guidance software that the step is complete. After the user 192 actuates the actuator 324, the installation guidance software may provide installation guidance instructions for the next step of the installation process.

As shown in FIG. 3D, the installation guidance software may provide instructions for disconnecting the next wire 335 from the switch 204 that is currently installed and connecting the wire 335 to the replacement device being installed. For example, the wire 335 may be a red wire that is identified as a traveler wire or a third hot terminal connected to a terminal screw 337 on the switch 204. The installation guidance software may display a prompt 332 on the display 194 of the user device 190 that provides instructions to the user 192 for properly connecting the wire 335 to the replacement device. The installation guidance software may display an indicator 336 (e.g., a circle) that identifies the tagged wire 335 (e.g., the tagged wire).

The installation guidance software may display an indicator 340 on the image 308 that identifies a location to attach the wire 335 on the replacement device being installed. The indicator 336 may display a color that corresponds to the wire 335 (e.g., the tagged wire) being detached from the currently installed device and being connected to the replacement device being installed. For example, the indicator 336 may be colored red to indicate the wire 335 that is being removed and attached to the replacement device. The indicator 340 may display a color that corresponds to the location to which the wire 335 (e.g., the tagged wire) is to be installed on the replacement device. For example, the indicator 340 may be colored blue to indicate the color of the traveling terminal screw on the replacement device. The color of the indicators 336, 340 may assist the user in tracking the wire that has been disconnected from the switch 204 and the corresponding location on the replacement device during the installation process. Though the colors of the indicators 336, 340 may be different, the colors may alternatively be the same to show a correspondence between the wire and the device location for being installed. In another example, the installation guidance software may alternatively and/or additionally draw a line on the image being displayed or provide another indication of the correspondence between the wire 335 and the location to which the wire is to be connected on the replacement device being installed. The wire 335 (e.g., the tagged wire) may be stored in memory with a location to be installed on the replacement device, which may be retrieved and provided to the user on the display 194.

The installation guidance software may include an actuator 334 (e.g., on the prompt 332 on the display 194 of the user device 190). The actuator 334 may be actuated after the user has installed the wire 335 on the replacement device to indicate to the installation guidance software that the step is complete. After the user 192 actuates the actuator 334, the installation guidance software may provide the next step of the installation guidance procedure.

After the wires have each been removed and connected to the replacement device, the installation guidance software may provide instructions on installing the replacement device in the wall box to finish the installation. For example, as shown in FIG. 3E, the installation guidance software may display a prompt 342 to the user that instructs the user to install the wired replacement switch 346 in the wall box and attach the wall plate. The installation guidance software may also display an actuator 344 to complete the installation guidance procedure and to indicate to the installation guidance software that the step is complete.

The installation guidance software may provide as many steps as needed for the installation guidance procedure for a given device or devices and a wiring installation. Though a number of steps and/or instructions may be provided herein as an example, the number of steps of the installation guidance procedure may vary. The number of steps may depend on the devices being installed and/or uninstalled, and/or the wiring installation. For example, different steps may be provided for 2-way lighting control devices, 3-way lighting control devices, 4-way lighting control devices, 2-wire lighting control devices, and/or 3-wire lighting control devices. Additionally, though steps may be provided as examples herein, steps may be reordered, added, or omitted from the examples herein. Additional steps may be included for providing instructions for adding a wire to the wiring installation where a wire that is needed for the replacement device is unrecognized in the tagged wires in the images. Though the FIGS. 3A-3E show an individual indicator for each wire and/or location on the replacement device in separate steps, the installation guidance software may display the indicators for multiple wires and/or locations on the replacement device at the same time. For example, the installation guidance software may display an indicator on each of the wires and each of the locations on the image 308 of the replacement device at the same time.

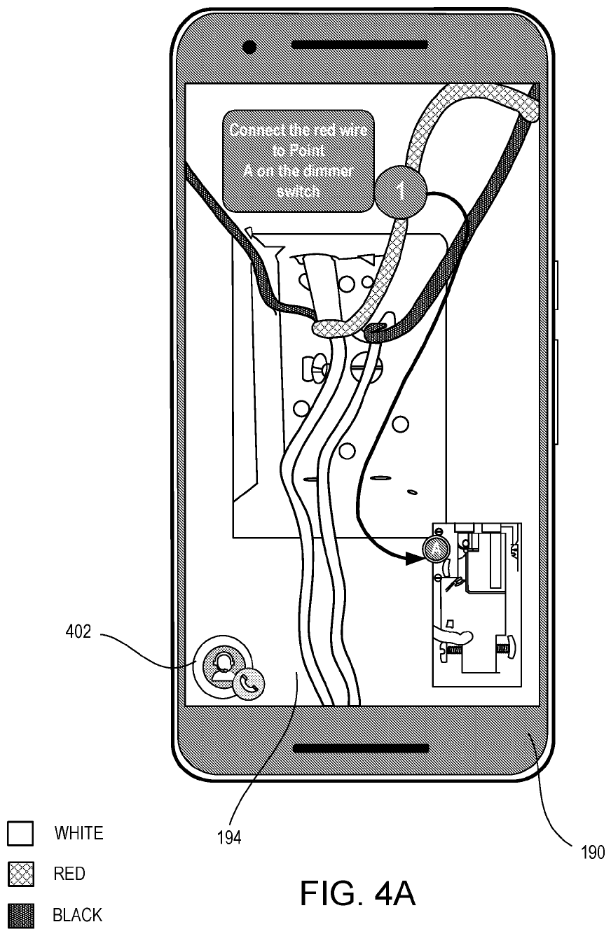

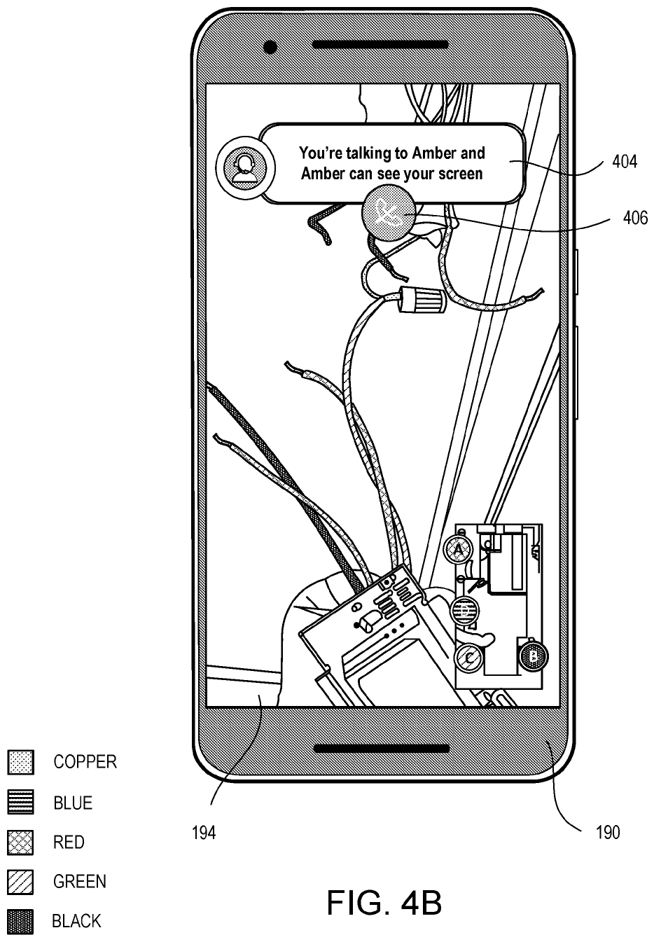

At any time during the installation guidance procedure, the installation guidance software may provide additional assistance to the user 192 by providing a customer support feature. FIGS. 4A and 4B provide examples of a user interface that may be displayed to the user 192 for providing such customer support features. As shown in FIG. 4A, the installation guidance software may display a customer support icon 402. The customer support icon 402 may be actuated by the user 192 to cause the application to call a customer support representative capable of providing additional assistance to the user 192 during the installation guidance procedure. The customer support representative may also be provided by the application with one or more images taken by the application using the camera 191 of the user device 190 to allow the customer support representative to provide live assistance. For example, the user device 190 may provide a video feed or one or more images of the installation to a remote computing device (e.g., the remote computing system 111 shown in FIG. 1A) to which the customer service representative has access in response to the actuation of the customer support icon 402 by the user. The installation guidance software may display a prompt 404 that indicates to the user 192 that the customer service representative has access to the images generated and displayed on the display 194. The user 192 may terminate the call and/or the video feed by actuating the button 406.

As described herein, the prompts, descriptors, actuators, and/or other elements of a graphical user interface may be overlaid over image(s) being displayed. For example, the installation guidance software may display one or more images captured by the camera of the user device and, after determining the information to be displayed, may overlay the information in the form of prompts, descriptors, actuators, and/or other elements of a graphical user interface on top of the image(s) being displayed in an application.

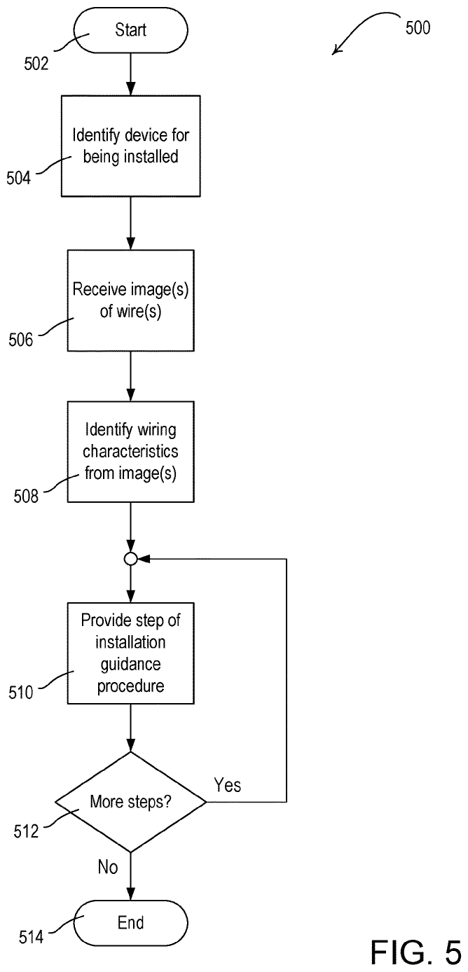

FIG. 5 is an example flowchart of a procedure 500 for providing guidance to a user installing a device in a load control system. The procedure 500 may be performed by one or more computing devices. For example, one or more portions of the procedure 500 may be performed by a user device, a system controller, or a remote computing system, such as the user device 190, the system controller 110, or the remote computing system 111 shown in FIG. 1A, or another computing device in the load control system. Though the procedure 500 may be described herein as being performed by a single device, the procedure 500 may be distributed across multiple devices, such as two or more of the user devices, the system controller, and/or the remote computing system. The user device, the system controller, and/or the remote computing system may be operating one or more portions of the installation guidance software to perform one or more portions of the procedure 500 herein. For example, one or more portions of the procedure 500 may be stored as computer-readable instructions or machine-readable instructions that may be executed by one or more processors at one or more computing devices.

The procedure 500 may begin at 502. At 504, a computing device may identify a device for being installed in the load control system. The device for being installed may be a load control device. For example, the device may be a lighting control device (e.g., the lighting control device 113 and/or the lighting control device 120 shown in FIG. 1A). The computing device may be a user device that may identify the device for being installed automatically, based on an image received from a camera of the user device (e.g., the camera 191 of the user device 190). For example, the user device may generate images of the device being installed using the camera on the user device. The images may be processed locally on the user device, or may be transmitted to another computing device (e.g., the system controller 110 and/or the remote computing system 111 in FIG. 1A) for image processing. The image processing may be performed using trained AI/ML or another algorithm, as described herein. The image processing may be performed to identify one or more device characteristics and/or wiring characteristics as described herein. The computing device may identify the device for being installed by scanning a barcode or other code or identifier associated with the device for being installed. Additionally and/or alternatively, the computing device may identify the device for being installed based on input from a user of the user device (e.g., via a display of the user device). For example, the user device may prompt the user to select the device from a list of devices, and/or may prompt the user to confirm that an automatically-determined device is correct.

At 506, the computing device may receive one or more images of one or more wires in a wiring installation. For example, the user device may generate images of the wire(s) using the camera on the user device. The user of the user device may point the camera of the user device at the wiring installation, and the user device may (e.g., automatically) generate an image of the wiring installation. The user device, or another computing device performing one or more portions of the procedure 500, may receive the images of the wiring installation for processing the one or more images of the wires that are in view of the camera.

At 508, the computing device may identify one or more wiring characteristics from the information in the image(s). As described herein, the wiring characteristics may be identified from the one or more images using an AI/ML model or another algorithm, such as a linear regression algorithm that has been trained on training data to identify the wiring characteristics. The wiring characteristics that may be identified in the one or more images may include a wire length, a color of a covering material (e.g., insulation) of the wire(s), a thickness of the covering material of the wire(s), a type of exposed end of the wire coming out of the covering material, a gauge of the wire, a location or color of a terminal to which the wire is connected to a presently installed device, and/or other wiring characteristics. Bare copper wires, wires failing to have a covering material, and/or green wires may be identified as ground wires. Wires having a white or gray covering material may be identified as neutral wires. Wires having a black or red covering material may be identified as hot wires. Wires having a black or red covering may also, or alternatively be identified as traveler wires or hot wires. Wires having a covering material with a thickness identified above a threshold may be identified as hot wires and/or traveler wires. Wires having a covering material with a thickness identified below a threshold may be identified as neutral wires. Wires having a gauge below a threshold may be identified as a ground wire. Wires having a gauge above the threshold may be identified as hot, neutral, or traveler wires. The type of the exposed end may be detected by the texture of the exposed end of the wire. Different exposed ends may have a different texture based on whether the wire is a low-voltage wire or a high-voltage wire. The higher-voltage wire may be identified for carrying power or be identified as the hot wire.

After determining the one or more wiring characteristics of the wire(s), the computing device may provide one or more steps of an installation guidance procedure to the user at 510. For example, guided instructions may be provided as steps of the installation guidance procedure to the user based on the specific device type of the device for being installed and/or the wiring characteristics identified in the one or more images. Based on the wiring characteristics, certain types of wires may be identified in the wiring installation. The guided instructions may be provided to the user on the user device. For example, the user device may execute installation guidance software configured to provide the guided instructions to the user based on the wiring characteristics. The installation guidance software may be executed locally on the user device via a local app or application and/or may be executed on a remote computing device (e.g., the system controller 110 and/or the remote computing system 111) and provided to the user via a local app or application executing on the user device. The steps of the installation guidance procedure may instruct the user to connect the wire(s) to the device for being installed.

At 512, the computing device may determine whether there are more steps in the installation guidance procedure to provide to the user. For example, the previous step may have instructed the user to connect a first wire to a screw or wire on the device being installed and the computing device may determine whether a second wire exists in the image for being connected to the device. If there are more steps to provide to the user, the procedure 500 may return to 510 and provide a next step to the user for enabling installation of the device. The steps or instructions that are provided by the installation guidance software may be determined based on the descriptor, the wiring characteristics, and/or the device characteristics that have been previously determined. If there are no more steps to provide to the user, the procedure 500 may end at 514.

As described herein, one or more computing devices may be implemented for updating information that may be tagged in an image and/or stored in memory for utilization in an installation guidance procedure. For example, one or more wires may be tagged in one or more images. Each wire may be tagged in memory with a descriptor indicating a type of wire that has been identified from the at least one image. Tags may be removed for objects that may be mistakenly tagged as wires or that may not be used in the installation. Tags may be added for wires to be used in the installation. The descriptors for tags may be updated.

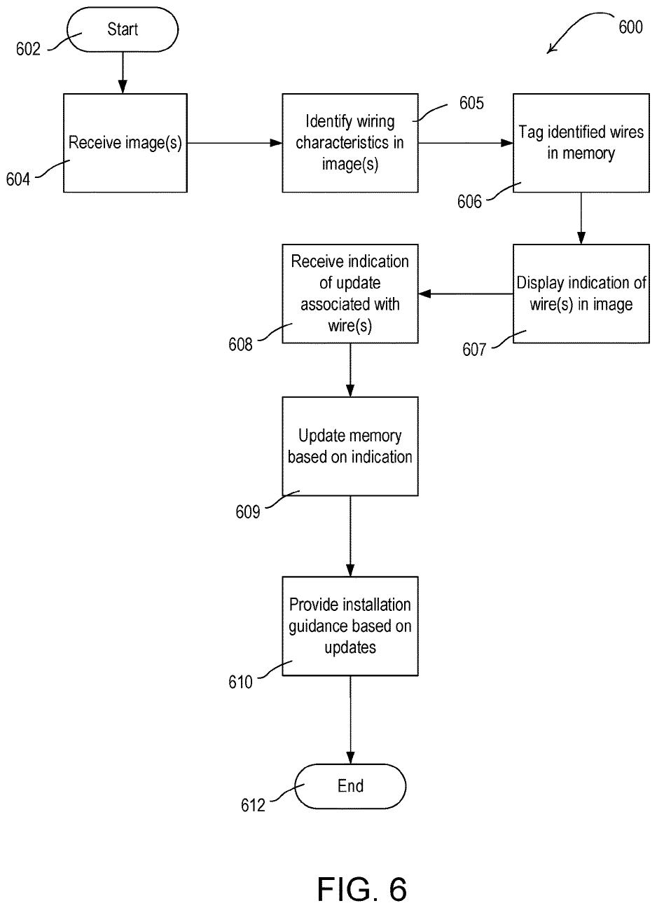

FIG. 6 is an example flowchart of a procedure 600 for updating an installation guidance procedure based on an indication to update. The procedure 600 may be performed by one or more computing devices. For example, one or more portions of the procedure 600 may be performed by a user device, a system controller, or a remote computing system, such as the user device 190 system controller 110, or the remote computing system 111 shown in FIG. 1A, or another computing device in the load control system. Though the procedure 600 may be described herein as being performed by a single device, the procedure 600 may be distributed across multiple devices, such as two or more of the user device, the system controller, and/or the remote computing system. The user device, the system controller, and/or the remote computing system may be operating one or more portions of the installation guidance software to perform one or more portions of the procedure 600 herein. For example, one or more portions of the procedure 600 may be stored as computer-readable instructions or machine-readable instructions that may be executed by one or more processors at one or more computing devices.

At 604, the computing device may receive one or more images. For example, the user device may generate images of the wire(s) in a wiring installation using the camera on the user device. The user of the user device may point the camera of the user device at the wiring installation, and the user device may (e.g., automatically) generate an image of the wires. The user device, or another computing device performing one or more portions of the procedure 600, may receive the images for processing the one or more images of the wires that are in view of the camera.

At 605, the computing device may identify one or more wiring characteristics from the information in the image(s). As described herein, the wiring characteristics may be identified from the one or more images using an AI/ML model or another algorithm, such as a linear regression algorithm that has been trained on training data to identify the device characteristics and/or wiring characteristics. At 606, the computing device may tag identified wires in the image(s) in memory based on the wiring characteristics. For example, the wires in the images may be defined by the identified wiring characteristics and the wiring characteristics may be associated with one or more descriptors. In another example, the computing device may receive user input (e.g., a screen touch) indicating a location within the image(s) at which the one or more wires may be located and the computing device may tag the identified location of the wires in memory. The tagged wires may be associated in memory with defined descriptors. The descriptors may be provided by the user (e.g., in a drop down menu) or may be determined by the computing device based on the wiring characteristics the device determines from the location identified by the user.

At 607, the computing device may display an indication of the tagged wires in the image. The indication may include a descriptor relative to the tagged wire in the image. For example, the user device may have a descriptor indicating a type of wire for each of the wires that has been identified from the at least one image stored in the memory. The descriptor may include a color of the wire, a color of a housing of the wire, a user-designated name associated with the wire, and/or another descriptor of the wire (e.g., that includes one or more wiring characteristics). The descriptor may be automatically generated by the computing device. The descriptor may be provided via text input or selected from a predefined list by the user.

At 608, the computing device may receive an indication of an update associated with the tagged wires. In a first example, the indication of the update may be received by an actuation by the user on the user device to remove one or more of the wires in the image from the representation stored in memory. For example, the computing device may mistakenly identify characteristics of an object in the one or more images as a wire, and the user may receive an actuation of a tag removal actuator(s) to remove the tagging of the one or more wires in memory. The user device may display the descriptor and the tag removal actuator for one or more of the identified wires on a display of the user device. A tag removal actuator corresponding to each tagged object (e.g., each wire) in the image may be displayed next to the object in the image and/or the descriptor. The user device may receive an indication of an actuation of the tag removal actuator for a wire via the display of the user device. For example, the tag removal actuator may be displayed on the user device as a button, and the user device may determine that the tag removal actuator has been actuated if the user device detects that the user has pressed/actuated the button. The computing device may update the display and/or the tags stored in memory based on the updates from the user.

Alternatively and/or additionally, the update may be to add one or more wires (e.g., or other objects) to the representation stored in memory. For example, the computing device may mistakenly fail to identify one or more wires in the image, and the user may use an add tag actuator to add a tag of the wire to memory. The user device may display the add tag actuator on the display of the user device, which may be actuated by the user to add a tag to an object in the image. The user device may receive an indication of an actuation of the add tag actuator via the display of the user device. For example, the add tag actuator may be displayed on the user device as a button, and the user device may determine that the add tag actuator has been actuated if the user device detects that the user has pressed/actuated the button. The user device may also receive an indication of a location of the wire in the image, for example with respect to one or more other objects in the image (e.g., other wires, devices, etc.), and/or a descriptor associated with the wire. For example, the user device may receive the indication of the location of the wire and/or the descriptor from the user. A new tag may be stored in memory based on the location of a user actuation on the screen to locate the wire in the image. The computing device may analyze the image at the selected location for wiring characteristics to be stored with a descriptor, or may merely store the location in the image selected by the user with the descriptor in memory. The descriptor may be automatically determined from the wiring characteristics or may be provided as input by the user. The descriptor may be displayed on the user device.

At 609, the computing device may update the memory of the computing device based on the received indication. For example, if the computing device has received an indication of an actuation of the tag removal actuator for a wire, the user device may remove the representation of the wire and/or the descriptor associated with the wire from the representation stored in memory. The user device may stop displaying the descriptor associated with the removed wire on the display of the user device. If the user device has received an indication of an actuation of the add actuator for a wire (e.g., a tagged wire), the user device may add a representation of the wire, the location of the wire, and/or the descriptor associated with the wire to the representation stored in memory. The user device may display the descriptor associated with the wire on the display of the user device. The user may update the descriptor being displayed by selecting on the descriptor and changing the descriptor for being stored in memory and/or displayed. For example, the descriptor of a green wire may be changed to a black wire. The instructions may be provided based on the updates from the user

At 610, the computing device may provide and/or update an installation guidance procedure based on the update to the memory of the user device. For example, the wire that has had the tag removed may not be processed by installation guidance software that is providing the installation guidance procedure. The installation guidance software may ignore the object when providing installation guidance instructions to the user (e.g., as described herein). Alternatively, a wire that has been added to the representation stored in memory may be used in the installation guidance procedure. The wiring characteristics and/or the descriptor may be utilized when determining and/or providing the step-by-step instructions in the installation guidance instructions. The installation guidance procedure may guide the user through installing the wires of the device for being installed, including the added wire. The procedure 600 may end at 612.

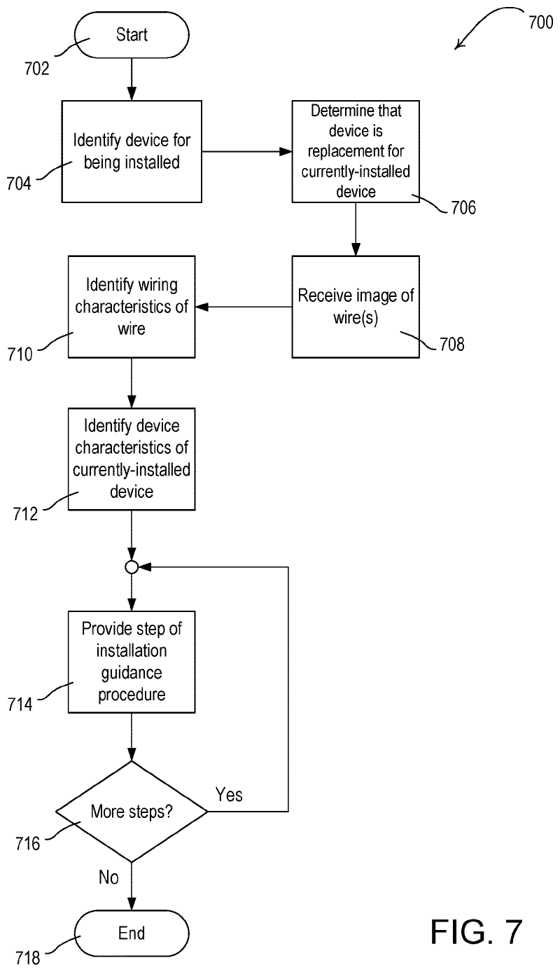

FIG. 7 is an example flowchart of a procedure 700 for another installation guidance procedure for replacing a currently installed device with a replacement device. The procedure 700 may be performed by one or more computing devices. For example, one or more portions of the procedure 700 may be performed by a user device or a remote computing system, such as the user device 190, system controller 110, or the remote computing system 111 shown in FIG. 1A, or another computing device in the load control system. Though the procedure 700 may be described herein as being performed by a single device, the procedure 700 may be distributed across multiple devices, such as two or more of the user device, the system controller, and/or the remote computing system. The user device, the system controller, and/or the remote computing system may be operating one or more portions of the installation guidance software to perform one or more portions of the procedure 700 herein. For example, one or more portions of the procedure 700 may be stored as computer-readable instructions or machine-readable instructions that may be executed by one or more processors at one or more computing devices.

The procedure 700 may begin at 702. At 704, the computing device may identify a device for being installed (e.g., a new or replacement device) in the load control system. The device for being installed may be a load control device. For example, the device may be a lighting control device (e.g., the lighting control device 113 and/or the lighting control device 120 shown in FIG. 1A). The computing device may identify the device for being installed automatically, based on an image received from a camera of the user device (e.g., the camera 191 of the user device 190). For example, the user device may generate images of the device being installed using the camera on the user device. The images may be processed locally on the user device, or may be transmitted to another computing device (e.g., the system controller 110 and/or the remote computing system 111 in FIG. 1A) for image processing. The computing device may identify the device for being installed by scanning a barcode or other code associated with the device for being installed. Additionally and/or alternatively, the computing device may identify the device for being installed based on input from a user of the user device (e.g., via a display of the user device). For example, the user device may prompt the user to select the device from a list of devices, and/or may prompt the user to confirm that an automatically-determined device is correct.

After the computing device identifies the device for being installed in the load control system, the computing device may determine at 706 that the device for being installed is a replacement for a currently-installed device (e.g., an old or presently installed device). The computing device may determine that the device for being installed is a replacement based on, for example, input from a user of the user device. For example, the user device may prompt the user to indicate that the device for being installed is a replacement device (e.g., by actuating a button on a display of the user device). Additionally and/or alternatively, the computing device may determine that the device for being installed is a replacement device based on detecting that a currently-installed device is present in the image(s) from the device characteristics (e.g., utilizing trained AI/ML or another algorithm).

At 708, the computing device may receive an image of one or more wires in a wiring installation. For example, the user device may generate images of the wire(s) using the camera on the user device. The user of the user device may point the camera of the user device at the wiring installation, and record one or more images. The wires may be connected to the replacement device.

At 710, the computing device may identify one or more wiring characteristics of the wire(s) in the image. As described herein, the wiring characteristics may be identified from the at least one image using AI/ML or another algorithm, such as a linear regression algorithm that has been trained on training data to identify the wiring characteristics. The wiring characteristics that may be identified in the images may include a wire length, a color of a covering material (e.g., insulation) of the wire(s), a thickness of the covering material of the wire(s), a type of exposed end of the wire coming out of the covering material, a gauge of the wire, a location or color of a terminal to which the wire is connected to a presently installed device, and/or other wiring characteristics. Bare copper wires, wires failing to have a covering material, and/or green wires may be identified as ground wires. Wires having a white or gray covering material may be identified as neutral wires. Wires having a black or red covering material may be identified as hot wires. Wires having a black or red covering may also, or alternatively be identified as traveler wires or hot wires. Wires having a covering material with a thickness identified above a threshold may be identified as hot wires and/or traveler wires. Wires having a covering material with a thickness identified below a threshold may be identified as neutral wires. Wires having a gauge below a threshold may be identified as a ground wire. Wires having a gauge above the threshold may be identified as hot, neutral, or traveler wires. The type of the exposed end may be detected by the texture of the exposed end of the wire. Different exposed ends may have a different texture based on whether the wire is a low-voltage wire or a high-voltage wire. The higher-voltage wire may be identified for carrying power or be identified as the hot wire.

At 712, the user device may identify one or more device characteristics of the currently-installed device (e.g., based on the image). The device characteristics that may be identified in the images may include a terminal color (e.g., terminal screw color), a terminal location (e.g., terminal screw location), a number of terminals (e.g., number of terminal screws), and/or other device characteristics. A terminal screw having a darker color than other terminal screws or a black color may be identified as a common terminal, a hot terminal, or a dimmed-hot terminal. A terminal screw having a lighter color than the common terminal or a brass color may be identified as traveler terminals or hot terminals. A screw having a green color may be identified as a ground screw. The number of terminals may be used to identify the type of device being wired. For example, a single-pole switch may be identified as having two brass terminal screws and a ground screw. A double-pole switch may be identified as having four brass terminal screws and one ground screw. A three-way switch may be identified as having three terminal screws (e.g., a darker or black terminal screw as common and two lighter or brass terminal screws) and a ground screw. A four-way switch may be identified as having four terminal screws (e.g., two lighter or brass terminal screws and two darker or black terminal screws) and a ground screw. Some switches may also have a neutral connection for connecting a neutral wire. The neutral connection or terminal screw may be identified as having a silver color. Though switches are provided as examples, it will be understood that switches may comprise on/off switches, dimmer switches, or another type of switch. Other electrical devices may similarly be connected as described herein and the device characteristics may be similarly identified for providing guided instructions. Additionally, though terminal screws are used as examples of device characteristics, the currently-installed device may also, or alternatively, have wires extending from the back of the device that may be identified based on the wire characteristics coming from the device. In another example, the currently-installed device may have stab-in connections that may be identified from the images. Furthermore, wiring characteristics above may similarly be used as device characteristics for establishing connections where the currently-installed device has wires extending therefrom.

At 714, the computing device may provide a step of an installation guidance procedure to the user. For example, the guided instructions may be based on the specific device type of the device for being installed and/or uninstalled. The guided instructions may be provided to the user on the user device. For example, the user device may execute installation guidance software configured to provide the guided instructions (e.g., an installation guidance procedure) to the user based on the wiring characteristics, device characteristics of the replacement device, and/or device characteristics of the currently installed device. The installation guidance software may be executed locally on the user device via a local app or application and/or may be executed on a remote computing device (e.g., the system controller 110 and/or the remote computing system 111) and provided to the user via a local app or application executing on the user device. The step of the installation guidance procedure may instruct the user to disconnect a wire from the currently-installed device and/or to connect the wire to the replacement device for being installed. For example, the user device may display a first indicator for the wire and a second indicator of a location on the replacement device for connecting the wire to the replacement device. The first indicator may be a color of the wire for which the first indicator is displayed, and the second indicator may be a color of a screw, a wire, or a terminal at the location on the replacement device to which the wire is to be connected to the replacement device.

At 716, the computing device may determine whether there are more steps in the installation guidance procedure to provide to the user. For example, the computing device may determine whether a second wire exists in the image. If there are more steps to provide to the user, the procedure 700 may return to 714 and provide a next step to the user for uninstalling the currently-installed device and/or installing the replacement device. The steps or instructions that are provided by the installation guidance software may be determined based on the descriptor, the wiring characteristics, and/or the device characteristics that have been previously determined. If there are no more steps to provide to the user, the procedure 700 may end at 718.

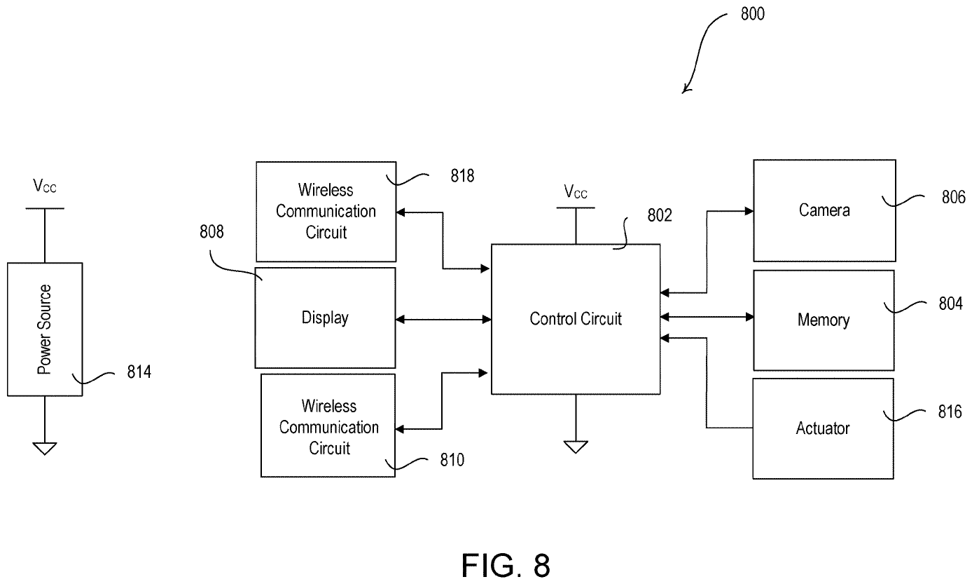

FIG. 8 is a block diagram illustrating an example computing device 800. For example, the computing device 800 may be a user device (such as the user device 190, described herein), a system controller (such as the system controller 110, described herein), a remote computing device (such as the remote computing system 111, described herein), an input device (such as remote control device 170), and/or another computing device as described herein. The computing device 800 may include a control circuit 802 for controlling the functionality of the computing device 800. The control circuit 802 may include one or more general purpose processors, special purpose processors, conventional processors, digital signal processors (DSPs), microprocessors, integrated circuits, a programmable logic device (PLD), application specific integrated circuits (ASICs), and/or the like. The control circuit 802 may perform signal coding, data processing, power control, image processing, input/output processing, and/or any other functionality that enables the computing device 800 to perform as described herein.

The control circuit 802 may store information in and/or retrieve information from the memory 804. The memory 804 may include a non-removable memory and/or a removable memory. The non-removable memory may include random-access memory (RAM), read-only memory (ROM), a hard disk, and/or any other type of non-removable memory storage. The removable memory may include a subscriber identity module (SIM) card, a memory stick, a memory card (e.g., a digital camera memory card), and/or any other type of removable memory. The memory 804 may have computer-executable instructions stored thereon that, when executed by the control circuit 802, cause the control circuit to execute one or more portions of the control/configuration application described herein. For example, the memory 804 may have computer-executable instructions stored thereon that, when executed by the control circuit 802, cause the control circuit to execute one or more portions of the installation guidance software described herein. The memory 804 of the input device may have instructions stored thereon that cause the control circuit 802 to transmit messages in response to actuation of an actuator 816.

The computing device 800 may include a camera 806 that may be in communication with the control circuit 802. The camera 806 may include a digital camera or other optical device configured to generating images or videos (e.g., image sequences) for being captured at the computing device 800 using visible light. The camera 806 may include a light configured to flashing, modulating, or turning on/off in response to signals received from the control circuit.

The computing device 800 may include a first wireless communication circuit 810 for transmitting and/or receiving information. The first wireless communication circuit 810 may perform wireless communications on a first wireless communication link and/or network (e.g., a network wireless communication link). The computing device 800 may also, or alternatively, include a second wireless communication circuit 818 for transmitting and/or receiving information. The second wireless communication circuit 818 may perform wireless communications via a second wireless communication link and/or network (e.g., a short-range wireless communication link). The first and second wireless communication circuit 810, 818 may be in communication with control circuit 802. The wireless communication circuits 810 and 818 may include RF transceivers or other communications modules configured to performing wireless communications via an antenna. The wireless communication circuit 810 and wireless communication circuit 818 may be configured to performing communications via the same communication channels or different communication channels. For example, the first wireless communication circuit 810 may be configured to communicating (e.g., with control devices and/or other devices in the load control system) via the first wireless communication link and/or network using a first wireless communication protocol (e.g., a network wireless communication protocol, such as the CLEAR CONNECT and/or THREAD protocols) and the second wireless communication circuit 818 may be configured to communicate via the second wireless communication channel and/or network using a second wireless communication protocol (e.g., a short-range wireless communication protocol, such as the BLUETOOTH and/or BLUETOOTH LOW ENERGY (BLE) protocols).

The control circuit 802 may also be in communication with a display 808. The display 808 may provide information to a user in the form of a graphical and/or textual display. The control circuit 802 may signal the display 808, or portions thereof, to modulate or turn on/off to communicate information from the display 808. The communication between the display 808 and the control circuit 802 may be a two-way communication, as the display 808 may include a touch screen module configured to receiving information from a user and providing such information to the control circuit 802.

The computing device 800 may include an actuator 816. The control circuit 802 may be responsive to the actuator 816 for receiving a user input. For example, the control circuit 802 may be operable to receive a button press from a user on the computing device 800 for making a selection, transmitting command messages, or performing other functionality on the computing device 800.

One or more of the circuits within the computing device 800 may be powered by a power source 814. The power source 814 may include an AC power supply or DC power supply, for example. The power source 814 may generate a DC supply voltage Vcc for powering the circuits within the computing device 800.

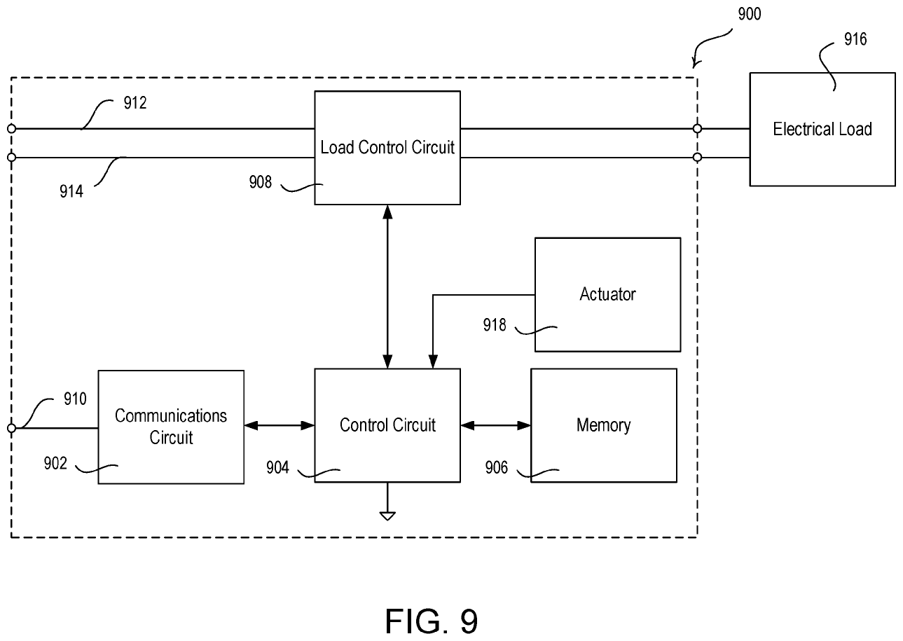

FIG. 9 is a block diagram illustrating an example load control device 900, as described herein. The load control device 900 may be a dimmer switch, an electronic switch, an electronic ballast for lamps, an LED driver for LED light sources, an AC plug-in load control device, a temperature control device (e.g., a thermostat), a motor drive unit for a motorized fan (e.g., ceiling fan), or other load control device. The load control device 900 may include a communication circuit 902. The communication circuit 902 may include a receiver, an RF transceiver, or other communications module configured to performing wired and/or wireless communications via communications link 910. The communication circuit 902 may be in communication with control circuit 904. The control circuit 904 may include one or more general purpose processors, special purpose processors, conventional processors, digital signal processors (DSPs), microprocessors, integrated circuits, a programmable logic device (PLD), application specific integrated circuits (ASICs), or the like. The control circuit 904 may perform signal coding, data processing, power control, input/output processing, or any other functionality that enables the load control device 900 to perform as described herein.

The control circuit 904 may store information in and/or retrieve information from the memory 906. For example, the memory 906 may maintain a registry of associated control devices and/or control instructions. The memory 906 may include a non-removable memory and/or a removable memory. The load control circuit 908 may receive instructions from the control circuit 904 and may control the electrical load 916 based on the received instructions.

The load control circuit 908 may send status feedback to the control circuit 904 regarding the status of the electrical load 916. The load control circuit 908 may receive power via the hot connection 912 and the neutral connection 914 and may provide an amount of power to the electrical load 916. The electrical load 916 may include any type of electrical load.

The control circuit 904 may be in communication with an actuator 918 (e.g., one or more buttons) that may be actuated by a user to communicate user selections to the control circuit 904. For example, the actuator 918 may be actuated to put the control circuit 904 in an association mode and/or communicate association messages from the load control device 900.

Although features and elements are described herein in particular combinations, each feature or element can be used alone or in any combination with the other features and elements. For example, the functionality described herein may be described as being performed by a control device, such as a remote control device or a lighting device, but may be similarly performed by a hub device or a network device. The methods described herein may be implemented in a computer program, software, or firmware incorporated in one or more computer-readable media for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), removable disks, and optical media such as CD-ROM disks, and digital versatile disks (DVDs).

What is claimed is:

1.-18. (canceled)

19. A method for guiding a user through an installation procedure for installing a wall-box device, the method comprising:
identifying the wall-box device for being installed;
receiving one or more images from a camera of a user device, wherein the one or more images comprise one or more objects;
automatically identifying, from the one or more images, each of the one or more objects as a respective wire based on one or more wiring characteristics of the one or more objects;
automatically tagging each of the one or more objects with a respective descriptor that corresponds to the wire identified by the one or more wiring characteristics in a memory by associating the one or more wiring characteristics with the descriptor in the memory;
providing, via a display of the user device, the descriptor of each of the one or more tagged objects identified as a wire; and
providing, via the display of the user device, at least one step of the installation procedure on the user device for wiring the wall-box device based on at least one of the descriptor or the one or more wiring characteristics of each object identified as a wire.

20. The method of claim 19, wherein the descriptor further comprises a type of wire that has been identified from the one or more wiring characteristics.

21. The method of claim 20, wherein the type of wire comprises one or more of ground wire, a neutral wire, a hot wire, or a traveler wire.

22. The method of claim 19, further comprising:
displaying, via the display of the user device, a tag removal actuator for each object identified as a wire;
detecting an actuation of the tag removal actuator for one of the objects identified as a wire from the one or more images;
de-tagging the one of the objects identified as a wire from the memory, wherein de-tagging the one of the objects identified as a wire from the memory further comprises removing at least one of the descriptor of the object identified as a wire from the memory or the automatic tagging of the one or more wiring characteristics to the descriptor of the object identified as a wire; and
removing the descriptor of the object identified as a wire from the display.

23. The method of claim 22, further comprising:
displaying, via the display of the user device, an add tag addition actuator configured to tag a second object identified as a wire in the at least one image;
receiving an actuation of the add tag addition actuator;
subsequently receiving an indication of a location of the second object identified as a wire in the one or more images;
determining a descriptor of the second object identified as a wire;
storing at least one of the indication of the location of the second object identified as a wire in the one or more images, one or more wiring characteristics in the one or more images associated with the second object identified as a wire, or the descriptor of the second object identified as a wire in the memory;
displaying the descriptor of the second object identified as a wire on the display of the user device; and
providing, via the display of the user device, at least one step of the installation procedure using the second object identified as a wire.

24. The method of claim 23, wherein the indication of the location of the second image is received based on an actuation of the location on the display of the user device.

25. The method of claim 19, wherein the descriptor is provided in proximity to the one or more objects identified as a wire in the display.

26. The method of claim 19, wherein the wall-box device is a replacement device for being installed in place of a currently-installed device, the method further comprising:
identifying, from the one or more images, one or more device characteristics of the currently-installed device; and
providing, via the display of the user device, at least one step of the installation procedure for uninstalling the one or more objects identified as a wire from the currently-installed device based on the one or more wiring characteristics of the one or more objects identified as a wire and the one or more device characteristics of the currently installed device.

27. The method of claim 26, wherein the installation procedure comprises instructions for disconnecting each object identified as a wire of the one or more objects identified as a wire from the currently installed device and connecting the one or more objects identified as a wire to a location on the replacement device based on the one or more wiring characteristics of the one or more objects identified as a wire, the one or more device characteristics of the currently-installed device, and one or more device characteristics of the replacement device.

28. The method of claim 27, wherein the installation procedure is provided in a series of steps, and wherein each step in the series of steps is provided in response to a user input indicating a completion of a previous step in the series of steps.

29. The method of claim 28, further comprising:
providing, on the display of the user device, a first indicator for each object identified as a wire of the one or more objects identified as a wire that has been identified in the one or more images; and
providing, on the display of the user device, a second indicator of a location on the replacement device for connecting the one or more objects identified as a wire.

30. The method of claim 29, wherein the first indicator indicates a color of the one or more objects identified as a wire for which the first indicator is provided, and wherein the second indicator indicates a color of a screw, a wire, or a terminal at the location on the replacement device to which the object identified as a wire is to be connected to the replacement device.

31. The method of claim 29, further comprising:
providing, on the display of the user device, an image of the replacement device, wherein the second indicator is displayed on the image of the replacement device to indicate the location on the replacement device for connecting the one or more objects identified as a wire.

32. The method of claim 27, wherein the device characteristics comprise at least one of a terminal color, a terminal location, or a number of terminals.

33. The method of claim 19, wherein the one or more wiring characteristics of the one or more objects identified as a wire are identified from the one or more images using a machine learning algorithm, wherein the machine learning algorithm comprises at least one of a linear regression algorithm or a neural network that has been trained on training data to identify the one or more wiring characteristics.

34. The method of claim 19, further comprising:
displaying a customer support icon on the display of the user device;
in response to receiving an actuation of the customer support icon, calling a customer support representative at a remote computing system; and
in response to receiving the actuation of the customer support icon, providing a video feed or the one or more images captured by the camera of the user device to the remote computing system for access by the customer support representative.

35. The method of claim 19, further comprising:
displaying the one or more images on the user device, and wherein the descriptor and the at least one step are provided by being overlaid on the one or more images.

36. The method of claim 19, wherein the wall-box device is a lighting control device.

37. The method of claim 36, wherein the lighting control device is a dimmer switch.

38. At least one non-transitory computer readable storage medium with program instructions stored thereon that when executed by at least one control circuit, further cause the at least one control circuit to:
identify a wall-box device for being installed;
receive one or more images from a camera of a user device, wherein the one or more images comprise one or more objects;
automatically identify, from the one or more images, each of the one or more objects as a respective wire based on one or more wiring characteristics of the one or more objects;
automatically tag each of the one or more objects with a respective descriptor that corresponds to the wire identified by the one or more wiring characteristics in a memory by associating the one or more wiring characteristics with the descriptor in the memory;
provide, via a display of the user device, the descriptor of each of the one or more tagged objects identified as a wire; and
provide, via the display of the user device, at least one step of an installation procedure on the user device for wiring the device based on at least one of the descriptor or the one or more wiring characteristics of each object identified as a wire.

39. The at least one non-transitory computer readable storage medium of claim 38, wherein the descriptor further comprises a type of wire that has been identified from the one or more wiring characteristics.

40. The at least one non-transitory computer readable storage medium of claim 39, wherein the type of wire comprises one or more of ground wire, a neutral wire, a hot wire, or a traveler wire.

41. The at least one non-transitory computer readable storage medium of claim 38, wherein the program instructions, when executed by the at least one control circuit, further cause the at least one control circuit to:
display, via the display of the user device, a tag removal actuator for each object identified as a wire;
detect an actuation of the tag removal actuator for one of the objects identified as a wire from the one or more images;
de-tag the one of the objects identified as a wire from the memory, wherein de-tagging the one of the objects identified as a wire from the memory further comprises removing at least one of the descriptor of the object identified as a wire from the memory or the automatic tagging of the one or more wiring characteristics to the descriptor of the object identified as a wire; and
remove the descriptor of the object identified as a wire from the display.

42. The at least one non-transitory computer readable storage medium of claim 41, wherein the program instructions, when executed by the at least one control circuit, further cause the at least one control circuit to:
display, via the display of the user device, an add tag addition actuator configured to tag a second object identified as a wire in the at least one image;
receive an actuation of the add tag addition actuator;
subsequently receive an indication of a location of the second object identified as a wire in the one or more images;
determine a descriptor of the second object identified as a wire;
store at least one of the indication of the location of the second object identified as a wire in the one or more images, one or more wiring characteristics in the one or more images associated with the second object identified as a wire, or the descriptor of the second object identified as a wire in the memory;
display the descriptor of the second object identified as a wire on the display of the user device; and
provide, via the display of the user device, at least one step of the installation procedure using the second object identified as a wire.

43. The at least one non-transitory computer readable storage medium of claim 42, wherein the indication of the location of the second image is received based on an actuation of the location on the display of the user device.

44. The at least one non-transitory computer readable storage medium of claim 38, wherein the descriptor is provided in proximity to the one or more objects identified as a wire in the display.

45. The at least one non-transitory computer readable storage medium of claim 38, wherein the wall-box device is a replacement device for being installed in place of a currently-installed device, wherein the program instructions, when executed by the at least one control circuit, further cause the at least one control circuit to:
identify, from the one or more images, one or more device characteristics of the currently-installed device; and
provide, via the display of the user device, at least one step of the installation procedure for uninstalling the one or more objects identified as a wire from the currently-installed device based on the one or more wiring characteristics of the one or more objects identified as a wire and the one or more device characteristics of the currently installed device.

46. The at least one non-transitory computer readable storage medium of claim 45, wherein the installation procedure comprises instructions for disconnecting each object identified as a wire of the one or more objects identified as a wire from the currently installed device and connecting the one or more objects identified as a wire to a location on the replacement device based on the one or more wiring characteristics of the one or more objects identified as a wire, the one or more device characteristics of the currently-installed device, and one or more device characteristics of the replacement device.

47. The at least one non-transitory computer readable storage medium of claim 46, wherein the installation procedure is provided in a series of steps, and wherein each step in the series of steps is provided in response to a user input indicating a completion of a previous step in the series of steps.

48. The at least one non-transitory computer readable storage medium of claim 47, wherein the program instructions, when executed by the at least one control circuit, further cause the at least one control circuit to:
provide, on the display of the user device, a first indicator for each object identified as a wire of the one or more objects identified as a wire that has been identified in the one or more images; and
provide, on the display of the user device, a second indicator of a location on the replacement device for connecting the one or more objects identified as a wire.

49. The at least one non-transitory computer readable storage medium of claim 48, wherein the first indicator indicates a color of the one or more objects identified as a wire for which the first indicator is provided, and wherein the second indicator indicates a color of a screw, a wire, or a terminal at the location on the replacement device to which the object identified as a wire is to be connected to the replacement device.

50. The at least one non-transitory computer readable storage medium of claim 48, wherein the program instructions, when executed by the at least one control circuit, further cause the at least one control circuit to:
provide, on the display of the user device, an image of the replacement device, wherein the second indicator is displayed on the image of the replacement device to indicate the location on the replacement device for connecting the one or more objects identified as a wire.

51. The at least one non-transitory computer readable storage medium of claim 46, wherein the device characteristics comprise at least one of a terminal color, a terminal location, or a number of terminals.

52. The at least one non-transitory computer readable storage medium of claim 38, wherein the one or more wiring characteristics of the one or more objects identified as a wire are identified from the one or more images using a machine learning algorithm, wherein the machine learning algorithm comprises at least one of a linear regression algorithm or a neural network that has been trained on training data to identify the one or more wiring characteristics.

53. The at least one non-transitory computer readable storage medium of claim 38, wherein the program instructions, when executed by the at least one control circuit, further cause the at least one control circuit to:
display a customer support icon on the display of the user device;
in response to receiving an actuation of the customer support icon, call a customer support representative at a remote computing system; and
in response to receiving the actuation of the customer support icon, provide a video feed or the one or more images captured by the camera of the user device to the remote computing system for access by the customer support representative.

54. The at least one non-transitory computer readable storage medium of claim 38, wherein the program instructions, when executed by the at least one control circuit, further cause the at least one control circuit to:
display the one or more images on the user device, and wherein the descriptor and the at least one step are provided by being overlaid on the one or more images.

55. The at least one non-transitory computer readable storage medium of claim 38, wherein the wall-box device is a lighting control device.

56. The at least one non-transitory computer readable storage medium of claim 38, wherein the lighting control device is a dimmer switch.

57. A computing device for guiding a user through an installation procedure for installing a wall-box device, the computing device comprising at least one control circuit configured to:
identify the wall-box device for being installed;
receive one or more images from a camera, wherein the one or more images comprise one or more objects;
automatically identify, from the one or more images, each of the one or more objects as a respective wire based on one or more wiring characteristics of the one or more objects;
automatically tag each of the one or more objects with a respective descriptor that corresponds to the wire identified by the one or more wiring characteristics in a memory by associating the one or more wiring characteristics with the descriptor in the memory;
provide, via a display, the descriptor of each of the one or more tagged objects identified as a wire; and
provide, via the display, at least one step of the installation procedure for wiring the wall-box device based on at least one of the descriptor or the one or more wiring characteristics of each object identified as a wire.

58. The computing device of claim 57, wherein the descriptor further comprises a type of wire that has been identified from the one or more wiring characteristics.

59. The computing device of claim 58, wherein the type of wire comprises one or more of ground wire, a neutral wire, a hot wire, or a traveler wire.

60. The computing device of claim 57, wherein the at least one control circuit is further configured to:
display, via the display, a tag removal actuator for each object identified as a wire;
detect an actuation of the tag removal actuator for one of the objects identified as a wire from the one or more images;
de-tag the one of the objects identified as a wire from the memory, wherein de-tagging the one of the objects identified as a wire from the memory further comprises removing at least one of the descriptor of the object identified as a wire from the memory or the automatic tagging of the one or more wiring characteristics to the descriptor of the object identified as a wire; and
remove the descriptor of the object identified as a wire from the display.

61. The computing device of claim 60, wherein the at least one control circuit is further configured to:
display, via the display, an add tag addition actuator configured to tag a second object identified as a wire in the at least one image;
receive an actuation of the add tag addition actuator;
subsequently receive an indication of a location of the second object identified as a wire in the one or more images;
determine a descriptor of the second object identified as a wire;
store at least one of the indication of the location of the second object identified as a wire in the one or more images, one or more wiring characteristics in the one or more images associated with the second object identified as a wire, or the descriptor of the second object identified as a wire in the memory;
display the descriptor of the second object identified as a wire on the display; and
provide, via the display, at least one step of the installation procedure using the second object identified as a wire.

62. The computing device of claim 61, wherein the indication of the location of the second image is received based on an actuation of the location on the display of the user device.

63. The computing device of claim 57, wherein the descriptor is provided in proximity to the one or more objects identified as a wire in the display.

64. The computing device of claim 57, wherein the wall-box device is a replacement device for being installed in place of a currently-installed device, wherein the at least one control circuit is further configured to:
identify, from the one or more images, one or more device characteristics of the currently-installed device; and
provide, via the display, at least one step of the installation procedure for uninstalling the one or more objects identified as a wire from the currently-installed device based on the one or more wiring characteristics of the one or more objects identified as a wire and the one or more device characteristics of the currently installed device.

65. The computing device of claim 64, wherein the installation procedure comprises instructions for disconnecting each object identified as a wire of the one or more objects identified as a wire from the currently installed device and connecting the one or more objects identified as a wire to a location on the replacement device based on the one or more wiring characteristics of the one or more objects identified as a wire, the one or more device characteristics of the currently-installed device, and one or more device characteristics of the replacement device.

66. The computing device of claim 65, wherein the installation procedure is provided in a series of steps, and wherein each step in the series of steps is provided in response to a user input indicating a completion of a previous step in the series of steps.

67. The computing device of claim 66, wherein the at least one control circuit is further configured to:
provide, on the display, a first indicator for each object identified as a wire of the one or more objects identified as a wire that has been identified in the one or more images; and
provide, on the display, a second indicator of a location on the replacement device for connecting the one or more objects identified as a wire.

68. The computing device of claim 67, wherein the first indicator indicates a color of the one or more objects identified as a wire for which the first indicator is provided, and wherein the second indicator indicates a color of a screw, a wire, or a terminal at the location on the replacement device to which the object identified as a wire is to be connected to the replacement device.

69. The computing device of claim 67, wherein the at least one control circuit is further configured to:
provide, on the display, an image of the replacement device, wherein the second indicator is displayed on the image of the replacement device to indicate the location on the replacement device for connecting the one or more objects identified as a wire.

70. The computing device of claim 65, wherein the device characteristics comprise at least one of a terminal color, a terminal location, or a number of terminals.

71. The computing device of claim 57, wherein the one or more wiring characteristics of the one or more objects identified as a wire are identified from the one or more images using a machine learning algorithm, wherein the machine learning algorithm comprises at least one of a linear regression algorithm or a neural network that has been trained on training data to identify the one or more wiring characteristics.

72. The computing device of claim 57, wherein the at least one control circuit is further configured to:
display a customer support icon on the display of the user device;
in response to receiving an actuation of the customer support icon, call a customer support representative at a remote computing system; and
in response to receiving the actuation of the customer support icon, provide a video feed or the one or more images captured by the camera of the user device to the remote computing system for access by the customer support representative.

73. The computing device of claim 57, wherein the at least one control circuit is further configured to:
display the one or more images on the user device, and wherein the descriptor and the at least one step are provided by being overlaid on the one or more images.

74. The computing device of claim 57, wherein the wall-box device is a lighting control device.

75. The computing device of claim 57, wherein the lighting control device is a dimmer switch.

76. The computing device of claim 57, wherein the computing device is a user device.

77. A method for guiding a user through an installation procedure for installing a replacement device, the method comprising:
identifying at least one device characteristic of the replacement device for being installed;
receiving one or more images from a camera of a user device, wherein the one or more images comprise one or more objects;
automatically identifying, from the one or more objects in the one or more images, at least one wire based on one or more wiring characteristics of the one or more objects;
automatically identifying, from the one or more objects in the one or more images, at least one device characteristic of a currently-installed device; and
providing, via the display of the user device based on the at least one device characteristic of the currently-installed device, the one or more wiring characteristics, and the at least one device characteristic of the replacement device, at least one step of the installation procedure for uninstalling the one or more objects identified as the at least one wire from the currently-installed device and installing the one or more objects identified as the at least one wire on the replacement device.

78. The method of claim 77, wherein the installation procedure comprises instructions for disconnecting each object identified as a wire of the one or more objects from the currently-installed device and connecting each object identified as a wire of the one or more objects to a location on the replacement device based on the one or more wiring characteristics of the one or more objects identified as a respective wire, the one or more device characteristics of the currently installed device, and one or more device characteristics of the replacement device.

79. The method of claim 78, wherein the installation procedure is provided in a series of steps, and wherein each step in the series of steps is provided in response to a user input indicating a completion of a previous step in the series of steps.

80. The method of claim 79, further comprising:
providing, on the display of the user device, a first indicator for each object identified as a wire of the one or more objects in the one or more images; and
providing, on the display of the user device, a second indicator of a location on the replacement device for connecting the one or more objects identified as a respective wire.

81. The method of claim 80, wherein the first indicator indicates a color of the one or more objects identified as a wire for which the first indicator is provided, and wherein the second indicator indicates a color of a screw, a wire, or a terminal at the location on the replacement device to which the object identified as a wire is to be connected to the replacement device.

82. The method of claim 80, further comprising:
providing, on the display of the user device, an image of the replacement device, wherein the second indicator is displayed on the image of the replacement device to indicate the location on the replacement device for connecting the one or more objects identified as a wire.

83. The method of claim 80, wherein the device characteristics of the currently installed device comprise at least one of a terminal color, a terminal location, or a number of terminals.

84. At least one non-transitory computer readable storage medium with program instructions stored thereon that when executed by at least one control circuit, further cause the at least one control circuit to:
identify at least one device characteristic of a replacement device for being installed;
receive one or more images from a camera of a user device, wherein the one or more images comprise one or more objects;
automatically identify, from the one or more objects in the one or more images, at least one wire based on one or more wiring characteristics of the one or more objects;
automatically identify, from the one or more objects in the one or more images, at least one device characteristic of a currently installed device; and
provide, via a display of the user device based on the at least one device characteristic of the currently installed device, the one or more wiring characteristics, and the at least one device characteristic of the replacement device, at least one step of an installation procedure for uninstalling the one or more objects identified as the at least one wire from the currently installed device and installing the one or more objects identified as the at least one wire on the replacement device.

85. The least one non-transitory computer readable storage medium of claim 84, wherein the installation procedure comprises instructions for disconnecting each object identified as a wire of the one or more objects from the currently-installed device and connecting each object identified as a wire of the one or more objects to a location on the replacement device based on the one or more wiring characteristics of the one or more objects identified as a respective wire, the one or more device characteristics of the currently installed device, and one or more device characteristics of the replacement device.

86. The least one non-transitory computer readable storage medium of claim 85, wherein the installation procedure is provided in a series of steps, and wherein each step in the series of steps is provided in response to a user input indicating a completion of a previous step in the series of steps.

87. The least one non-transitory computer readable storage medium of claim 86, wherein the program instructions, when executed by the at least one control circuit, further cause the at least one control circuit to:
provide, on the display of the user device, a first indicator for each object identified as a wire of the one or more objects in the one or more images; and
provide, on the display of the user device, a second indicator of a location on the replacement device for connecting the one or more objects identified as a respective wire.

88. The least one non-transitory computer readable storage medium of claim 87, wherein the first indicator indicates a color of the one or more objects identified as a wire for which the first indicator is provided, and wherein the second indicator indicates a color of a screw, a wire, or a terminal at the location on the replacement device to which the object identified as a wire is to be connected to the replacement device.

89. The least one non-transitory computer readable storage medium of claim 87, wherein the program instructions, when executed by the at least one control circuit, further cause the at least one control circuit to:
provide, on the display of the user device, an image of the replacement device, wherein the second indicator is displayed on the image of the replacement device to indicate the location on the replacement device for connecting the one or more objects identified as a wire.

90. The least one non-transitory computer readable storage medium of claim 87, wherein the device characteristics of the currently installed device comprise at least one of a terminal color, a terminal location, or a number of terminals.

91. A computing device for providing guidance to a user in an installation procedure for installing a replacement device, the computing device comprising at least one control circuit configured to:
identify at least one device characteristic of the replacement device for being installed;
receive one or more images from a camera, wherein the one or more images comprise one or more objects;
automatically identify, from the one or more objects in the one or more images, at least one wire based on one or more wiring characteristics of the one or more objects;
automatically identify, from the one or more objects in the one or more images, at least one device characteristic of a currently installed device; and
provide, via a display based on the at least one device characteristic of the currently installed device, the one or more wiring characteristics, and the at least one device characteristic of the replacement device, at least one step of the installation procedure for uninstalling the one or more objects identified as the at least one wire from the currently installed device and installing the one or more objects identified as the at least one wire on the replacement device.

92. The computing device of claim 91, wherein the installation procedure comprises instructions for disconnecting each object identified as a wire of the one or more objects from the currently-installed device and connecting each object identified as a wire of the one or more objects to a location on the replacement device based on the one or more wiring characteristics of the one or more objects identified as a respective wire, the one or more device characteristics of the currently installed device, and one or more device characteristics of the replacement device.

93. The computing device of claim 92, wherein the installation procedure is provided in a series of steps, and wherein each step in the series of steps is provided in response to a user input indicating a completion of a previous step in the series of steps.

94. The computing device of claim 93, wherein the at least one control circuit is further configured to:
provide, on the display of the user device, a first indicator for each object identified as a wire of the one or more objects in the one or more images; and
provide, on the display of the user device, a second indicator of a location on the replacement device for connecting the one or more objects identified as a respective wire.

95. The computing device of claim 94, wherein the first indicator indicates a color of the one or more objects identified as a wire for which the first indicator is provided, and wherein the second indicator indicates a color of a screw, a wire, or a terminal at the location on the replacement device to which the object identified as a wire is to be connected to the replacement device.

96. The computing device of claim 94, wherein the at least one control circuit is further configured to:
provide, on the display of the user device, an image of the replacement device, wherein the second indicator is displayed on the image of the replacement device to indicate the location on the replacement device for connecting the one or more objects identified as a wire.

97. The computing device of claim 94, wherein the device characteristics of the currently installed device comprise at least one of a terminal color, a terminal location, or a number of terminals.

98. The computing device of claim 91, wherein the computing device comprises a user device.

99. A method comprising:
receiving one or more images from a camera of a user device, wherein the one or more images comprise one or more objects;
automatically identifying, from the one or more images, each of the one or more objects as a respective wire based on one or more wiring characteristics of the one or more objects;
automatically tagging each of the one or more objects with a respective descriptor that corresponds to the wire identified by the one or more wiring characteristics in a memory by associating the one or more wiring characteristics with the descriptor in the memory;
receiving an indication of a change to the descriptor of one or more objects of the tagged one or more objects identified as a wire;
changing the descriptor of the tagged one or more objects in the memory based on the indication of the change to the descriptor of one or more objects of the tagged one or more objects identified as a wire; and
providing, via a display of the user device, at least one step of the installation procedure on the user device for wiring a wall-box device based on the change to the descriptor of the one or more objects of the tagged one or more objects identified as a wire.

100. The method of claim 99, further comprising:
displaying, via the display of the user device, a tag removal actuator for each object identified as a wire, wherein the indication of the change to the descriptor of the one or more objects comprises an actuation of the tag removal actuator, wherein the change to the descriptor of the one or more objects is performed by de-tagging the one of the objects identified as a wire from the memory based on the actuation of the tag removal actuator, wherein de-tagging the one of the objects identified as a wire from the memory comprises removing at least one of the descriptor of the object identified as a wire or the automatic tagging of the one or more wiring characteristics to the descriptor of the object identified as a wire from memory; and
removing the descriptor of the object identified as a wire from the display.

101. The method of claim 99, wherein each of the one or more objects is automatically identified as the respective wire using an artificial intelligence/machine learning (AI/ML) model trained on training data of different wiring characteristics of objects in images to identify, from the images, each of the one or more objects as the respective wire based on the one or more wiring characteristics.

102. The method of claim 101, further comprising:
using the change to the descriptor of the one or more objects to improve the AI/ML model for automatically identifying wires from objects in images.

103. The method of claim 102, wherein using the change to the descriptor of the one or more objects to improve the AI/ML model further comprises training the AI/ML model to identify objects that failed to be recognized in the one or more images based on the change to the descriptor of the one or more objects.

104. At least one non-transitory computer readable storage medium with program instructions stored thereon that when executed by at least one control circuit, further cause the at least one control circuit to:
receive one or more images from a camera of a user device, wherein the one or more images comprise one or more objects;
automatically identify, from the one or more images, each of the one or more objects as a respective wire based on one or more wiring characteristics of the one or more objects;
automatically tag each of the one or more objects with a respective descriptor that corresponds to the wire identified by the one or more wiring characteristics in a memory by associating the one or more wiring characteristics with the descriptor in the memory;
receive an indication of a change to the descriptor of one or more objects of the tagged one or more objects identified as a wire;
change the descriptor of the tagged one or more objects in the memory based on the indication of the change to the descriptor of one or more objects of the tagged one or more objects identified as a wire; and
provide, via a display of the user device, at least one step of an installation procedure on the user device for wiring a wall-box device based on the change to the descriptor of the one or more objects of the tagged one or more objects identified as a wire.

105. The at least one non-transitory computer readable storage medium of claim 104, wherein the program instructions, when executed by the at least one control circuit, further cause the at least one control circuit to:
display, via the display of the user device, a tag removal actuator for each object identified as a wire, wherein the indication of the change to the descriptor of the one or more objects comprises an actuation of the tag removal actuator, wherein the change to the descriptor of the one or more objects is performed by de-tagging the one of the objects identified as a wire from the memory based on the actuation of the tag removal actuator, wherein de-tagging the one of the objects identified as a wire from the memory comprises removing at least one of the descriptor of the object identified as a wire or the automatic tagging of the one or more wiring characteristics to the descriptor of the object identified as a wire from memory; and
remove the descriptor of the object identified as a wire from the display.

106. The at least one non-transitory computer readable storage medium of claim 104, wherein each of the one or more objects is automatically identified as the respective wire using an artificial intelligence/machine learning (AI/ML) model trained on training data of different wiring characteristics of objects in images to identify, from the images, each of the one or more objects as the respective wire based on the one or more wiring characteristics.

107. The at least one non-transitory computer readable storage medium of claim 106, wherein the program instructions, when executed by the at least one control circuit, further cause the at least one control circuit to:
use the change to the descriptor of the one or more objects to improve the AI/ML model for automatically identifying wires from objects in images.

108. The at least one non-transitory computer readable storage medium of claim 107, wherein the program instructions, when executed by the at least one control circuit, causing the at least one control circuit to use the change to the descriptor of the one or more objects to improve the AI/ML model further comprises the program instructions, when executed by the at least one control circuit, causing the at least one control circuit to train the AI/ML model to identify objects that failed to be recognized in the one or more images based on the change to the descriptor of the one or more objects.

109. A computing device comprising at least one control circuit configured to:
receive one or more images from a camera, wherein the one or more images comprise one or more objects;
automatically identify, from the one or more images, each of the one or more objects as a respective wire based on one or more wiring characteristics of the one or more objects;
automatically tag each of the one or more objects with a respective descriptor that corresponds to the wire identified by the one or more wiring characteristics in a memory by associating the one or more wiring characteristics with the descriptor in the memory;
receive an indication of a change to the descriptor of one or more objects of the tagged one or more objects identified as a wire;
change the descriptor of the tagged one or more objects in the memory based on the indication of the change to the descriptor of one or more objects of the tagged one or more objects identified as a wire; and
provide, via a display, at least one step of an installation procedure for wiring a wall-box device based on the change to the descriptor of the one or more objects of the tagged one or more objects identified as a wire.

110. The computing device of claim 109, wherein the at least one control circuit is further configured to:
display, via the display, a tag removal actuator for each object identified as a wire, wherein the indication of the change to the descriptor of the one or more objects comprises an actuation of the tag removal actuator, wherein the change to the descriptor of the one or more objects is performed by de-tagging the one of the objects identified as a wire from the memory based on the actuation of the tag removal actuator, wherein de-tagging the one of the objects identified as a wire from the memory comprises removing at least one of the descriptor of the object identified as a wire or the automatic tagging of the one or more wiring characteristics to the descriptor of the object identified as a wire from memory; and
remove the descriptor of the object identified as a wire from the display.

111. The computing device of claim 109, wherein each of the one or more objects is automatically identified as the respective wire using an artificial intelligence/machine learning (AI/ML) model trained on training data of different wiring characteristics of objects in images to identify, from the images, each of the one or more objects as the respective wire based on the one or more wiring characteristics.

112. The computing device of claim 111, wherein the at least one control circuit is further configured to:
use the change to the descriptor of the one or more objects to improve the AI/ML model for automatically identifying wires from objects in images.

113. The computing device of claim 112, wherein the at least one control circuit configured to use the change to the descriptor of the one or more objects to improve the AI/ML model further comprises the at least one control circuit being configured to train the AI/ML model to identify objects that failed to be recognized in the one or more images based on the change to the descriptor of the one or more objects.

114. The computing device of claim 109, wherein the computing device comprises a user device.
